(19) United States
(12) Patent Application Publication
(10) Pub. No.: US 2009/0192862 A1
(43) Pub. Date: Jul. 30, 2009

(54) SYSTEM AND METHOD FOR SEAMLESSLY INTEGRATING THE LISTING AND SALE OF REAL PROPERTY

(76) Inventor: Wesley B. HOGGARD, Norfolk, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/039,710

(22) Filed: Feb. 28, 2008

Related U.S. Application Data
(60) Provisional application No. 60/892,586, filed on Mar. 2, 2007.

(51) Int. Cl. G06Q 50/00; G06F 17/30; G06Q 30/00

(52) U.S. Cl. 705/9; 707/104.1; 707/3; 705/14; 707/E17.044; 707/E17.108; 707/E17.032; 705/27

(57) ABSTRACT

A system and method for allowing a plurality of Sellers of real estate to either list their real estate “By Owner” or “By Agent.” Those Sellers that list “By Owner” may select a time period after which their property may be converted to a “By Agent” listing. “By Owner” Sellers may choose to “push” their listing to only Agents that specialize in selling a particular type of property within the geographic region of the property. Agents may also offer their services to “By Owner” Sellers that have listed properties matching the Agent's specialty. Real estate Buyers may, through a single interface, access all properties that meet the Buyers' criteria, whether listed “By Owner” or “By Agent.”

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent and files of record, but otherwise reserves all copyright rights whatsoever.

### TECHNICAL FIELD

The invention relates generally to the operation of an online real estate advertising service between Buyers and Sellers of real estate. Specifically, the invention relates to uniquely merging existing methods for buying and selling real estate and making them available through one comprehensive search engine. Additionally, this system provides the real estate Owner and Agents with the tools necessary to: communicate, advertise, and attract Buyers and Sellers. The system is designed to distribute (or push) real estate listed “By Owner,” as directed by the owner after an owner-specified time period, to real estate Agents that specialize in selling in a particular real estate niche market within a given geographic region.

### BACKGROUND

Traditional online real estate advertising attempts to identify and bring together Buyers and Sellers of real estate through ads and virtual tours. Searching for real estate has become one of the highest categories for Internet traffic. Most online real estate advertising companies have chosen to protect consumer interest by lowering the cost of real estate fees and proclaiming an anti-Realtor® or Agent message to patrons. These sites only offer advertisements of real estate for sale by Owner, in which they proclaim they will provide the Seller with reduced transaction costs. Other sites, such as Yahoo®, allow the user to search a database specifically categorized as “for sale by Owner,” and another database that contains multi-listing services (“MLS”) listings. However, no website combines the two databases together into one convenient search.

The sites that are gaining an increasing number of advertisers are the ones proclaiming this anti-Agent message. In the United States alone, more than one in three Americans (100 million consumers) each year look at real estate advertisements. This is why Yahoo®, AOL®, MSN®, and Google®, representing 75% of all Internet users, are interested in real estate advertisements. Moreover, in order to connect with consumers, many advertisers are shifting their advertising dollars from the offline to the online world. Online real estate advertising will grow to a $2 billion dollar industry this year and swell to $3 billion by 2010, surpassing the long time leader in real estate advertising—Newspapers. Almost every other online company vying for consumers in the real estate category has chosen an exclusive consumer bias. These companies wrap themselves in a flag of protecting consumer interest and lowering the cost of real estate fees, while freely proclaiming their anti-Agent message to the world.

Google is the self-appointed “Do No Evil” company. Its goal was to build the best search engine on the planet. Late in 2005, Google quietly announced Google Base. Google Base is not a search site, it is a destination site; and the difference is quite remarkable. Search engines are designed to quickly move consumers through them to someone else's site. Destination sites are designed to keep consumers on their sites as long as possible to generate more advertising revenue. This suggests Google plans for Google Base to become a destination site for every major industry category, particLlarly the most popular ones—including real estate.

Many Buyers and Sellers select an Agent based on previous experience with that Agent. Because consumer loyalty is based on trusts any new site seeking to attract both the consumer and the Agent must develop a reputation as a trusted site. Many industry observers, however, believe that the goals of satisfying consumer needs while still employing the skills of an Agent are incongruent. Without question, Vertical Search Engines, such as AOL, Yahoo, Google, MSN, Trulia, and Prop smart, are positioned to enter the battle for control of the real estate consumer. Almost one-third of real estate firms already have at least one agreement with a lead generation company that provides the firm with customer-contact information in exchange for a fee (a majority of firms also generate leads from their own website or via Internet advertising). While many of the entities providing vertical search engines may not be overtly proclaiming their intent to displace Agents, they certainly are striving to reduce or redirect commissions away from Agents by grabbing the attention of the consumer early in the sales process. Nevertheless, the housing market today contrasts sharply with predictions a decade ago that the Internet would “disintermediate” real estate Agents, including speculation that the National Association of Realtors (“NAR”) membership would fall in half. In reality, NAR's membership has grown dramatically. Further, the MLS still represents about 80% of all available homes.

Vertical Search Engines are positioned to extract significant economics from Agents. Most industry controlled sites will effectively be subordinated to these sites, making significant referral fees a natural consequence. A Google Base (website), with its enormous traffic advantage, likely will become the de facto national MLS. But this will be a MLS without rules and reliance on Agents, leaving Agents with no way to compete for traffic. If any of the sites begin offering services similar to Realtor.com, they could completely dominate the on-line real estate market.

NAR, “the voice for real estate,” is America's largest trade association, representing more than 1.2 ilion members involved in all aspects of the residential and commercial real estate industry. NAR has partnered with a public company, Move, Inc., to promote the industries content and the value of Agents to consumers throughout the Internet. Move, Inc. pays tens of millions of dollars to MSN and AOL real estate, to channel traffic to its site from these portals. Realtor.com is the number one consumer real estate site based on consumer visits and minutes spent on the site. Realtor.com and Move.com are positioned to target the interest of the real estate information quest—“the true first point of contact” with the industry. Using Move.com, MSN and AOL to channel traffic to Realtor.com may not, however, be enough to stop the momentum of the other major online players.

Despite trust and loyalty being in short supply in an online world, a trusted brand is vital to protect and enhance Agent value. Homes sold by a real estate Agent sell for sixteen percent higher on average than those sold by an unrepresented Seller, according to NAR's 2005 Profile of Home Buyers and Sellers. While nine out of ten home Buyers use a real estate Agent in the search process, use of the Internet to search for a home has risen dramatically, increasing from only two percent of Buyers in 1995 to seventy-seven percent in 2005. Eighty-one percent of Buyers who use the Internet to search for a home still purchase through a real estate Agent. Any website hoping to gain Agent trust must promote the Agent's involvement to consumers to win the Agent's confidence.

Many Agents, however, are short-term focused. They want the quickest sale possible. Yet most Agents do not have their own websites where they can showcase their listings. According to NAR, both Buyers and Sellers use traditional methods to choose a real estate Agent. Word-of-mouth recommendation is the most common way to learn about real estate professionals. The most important criteria, whether buying or selling, are the individual Agent's reputation and their knowledge of the local market.

More than forty percent of all real estate firms participate in some type of referral or affinity program. Twenty percent of all firms have their own affinity program to generate leads including: affinity, corporate relocation, and Internet lead generation. Over one-third of real estate firms offer a reduction in the commission percentage amount as a benefit to both home Buyers and Sellers who are members of an affinity group.

No website currently offers the ability for prospective Buyers to simultaneously view listings from both Owners and Agents. Nor is there a website that connects Buyers and Sellers of real estate, as well as Agents, through the use of online chatting. With advancing technology forcing Buyers and Sellers to advertise online, there is an increasing need for a better method of identifying available real estate, finding an Agent, and coordinating the communication between Buyers, Sellers, and real estate Agents. Such a tool would reduce the apparent problem Agents are facing amongst anti-Agent websites, as well as limiting possible future problems where search engines gain control over real estate listings and are able to charge high referral fees to their Buyers.

### SUMMARY OF THE INVENTION

The invention consists of a system for retrieving real estate data from multiple databases through a single search based on a series of parameters entered by the prospective Buyer or an Agent acting on behalf of a Buyer.

In one embodiment, “character fields” or “attributes” that describe an Agent's Specialization, according to what type of properties they usually list/sell, or assist in purchasing when acting on behalf of a Buyer, are maintained in a database. This data will be retrieved when a Buyer or Seller of real estate is looking for an Agent to assist in either the buying or selling processes. If the user is a Seller or Owner of real estate and is looking for an Agent, the property's classification or attributes (i.e., the character fields describing the real estate including, for example, neighborhood, brick home, etc.) will be sent to Agents in that geographic area that specialize in selling that particular type of real estate (e.g., residential or commercial, selling price over $500,000, etc.). This feature may be used by Sellers in the initial listing process or For Sale By Owner (“FSBO”) Sellers that now wish to have their property listed with an Agent. For Agents attempting to acquire listings from FSBO Sellers, this feature minimizes the number of searches Agents currently must do through FSBO websites and provides the Agents with listings according to their specialty. For Buyers, the Agent Specialization database allows the Buyers to view lists of prospective Agents that specialize in selling properties possessing characteristics similar to the Buyer's property interests.

In this embodiment the system will allow users to search for Agents according to attributes associated with the Agent's specialty. A Seller of real estate will be able to describe the attributes of the real estate for sale, and Agents that specialize in that particular real estate within that particular geographic region will be retrieved from the database. Potential Sellers of real estate may then select an Agent according to the Agent's specialty classifications—thereby increasing the likelihood that the real estate will sell. Similarly, a Buyer of real estate may enter a list of property attributes based on the Buyer's interests. Agents that specialize in representing buyers who have purchased similar properties are then retrieved from the Agent Specialization database, allowing the prospective Buyer to select an Agent that may be able to better service the Buyer's needs.

In each of these embodiments, the user may choose to electronically communicate with the prospective Agent via an electronic mail system. The user may conduct electronic interviews of the several Agents, thereby providing the prospective Buyer or Seller with an efficient means of selecting an Agent.

In another embodiment, FSBO Sellers will be able to initially list their real estate as a FSBO listing, with the ability to convert the listing to “by Agent” if their property does not sell within the anticipated timeframe. The system does this by automatically distributing the FSBO listing, at a time specified by the FSBO Seller (i.e., the “By Owner Time Period”), to qualified Agents in the FSBO Seller's potential Target Marketing Region, and requests a response from those Agents. Agents receiving this request may electronically respond by providing additional information and answering any of the FSBO Seller's questions. The FSBO Seller may then select an Agent to list the property. Once the Agent is selected, the listing information stored in the FSBO database is automatically transferred to the listing Agent's database.

FSBO Sellers may also agree to pay a commission to Agents representing Buyers without converting the listing from a FSBO status to that of listed by an Agent. The system allows FSBO Sellers to change the commission rate at any time. Further, FSBO Sellers, who initially list their property without an associated commission, may specify that after a pre-determined time period, the Seller will agree to pay a commission to Agents representing Buyers and the system will automatically reflect this change. Similarly, the FSBO Seller may want to have the system automatically change the commission being offered (e.g., increase from two percent to three percent) after a pre-determined time period. Agents representing prospective Buyers may choose to view only those FSBO listings that offer the Buyer's Agent a commission. Included in this list will also be all qualifying properties listed by Agent as that listing will already have an associated commission.

Another embodiment allows Agents to upload both Agent listings and FSBO listings in order to attract potential Buyers to the Agent's services. This is done through the use of a membership area in which Agents are able to organize and keep track of their clients, including prospective, current and past Buyers and Sellers. Upload capabilities and online chatting will be available. This capability will especially help international Buyers and Sellers of real estate that wish to buy or sell from remote locations (e.g., other continents), as these international users depend almost exclusively on internet information. FSBO Sellers will also have membership capabilities, which will allow them to chat, store saved listings, and edit their listings.

In each embodiment of the invention, the FSBO Seller or the Seller's Agent have the ability to schedule an Open House. Notice of this Open House is then electronically transmitted to all Buyers, and Agents of Buyers, that have indicated an interest in properties possessing the characteristics or attributes of the specified property.

### BRIEF DESCRIPTION OF THE DRAWINGS

FIG. 1 depicts an overall system according to an embodiment of the present invention.

FIG. 2 depicts the various sub-systems included in an embodiment of the present invention.

FIGS. 3A and 3B depict a portion of the graphical user interface screens that allows Owners to establish a personal identity with the system according to an embodiment of the system.

FIGS. 4A-4G depict a process by which Agents may establish their profile including a number of the graphical user interface screens that allow Agents to input their personalized profile according to an embodiment of the system.

FIGS. 5A-5D depict a process by which Owners may establish a listing in the system including a number of graphical user interface screens that allow the Owners to input specific data concerning their properties according to an embodiment of the system.

FIGS. 6A-6C depict a process by which Owners may notify potential Agents of the Owners' interest in listing their property with an Agent including a number of the graphical user interface screens that allow Owners to notify potential Agents according to an embodiment of the system.

FIG. 7 depicts a graphical user interface screen by which Buyers may input certain criteria pertaining to properties the Buyers may find of interest according to an embodiment of the system.

FIGS. 8A-8G depict graphical user interface screens pertaining to the Communication Module that allows communication between all users of the system according to an embodiment of the system.

FIGS. 9A-9H depict a process by which Buyers and Agents may conduct property searches including a number of the graphical user interface screens used in this process according to an embodiment of the system.

FIGS. 10A-10F depict a process by which either Buyers or Sellers may identify and select Agents to assist in either the purchase or sale of property including a number of graphical user interface screens used in this process according to an embodiment of the system.

FIGS. 11A-11B depict a process by which a property initially listed By Owner may be converted to a property listed By Agent based on certain Owner specified transition criteria including a number of graphical user interface screens used to establish and maintain this process according to an embodiment of the system.

FIGS. 12A-12H depict a series of reporting screens allowing users of the system to access information from the system that may be used in the buying and selling processes according to an embodiment of the system.

FIGS. 13A-13D depict how various users of the system may share information with each other according to an embodiment of the system.

### DETAILED DESCRIPTION OF EMBODIMENTS

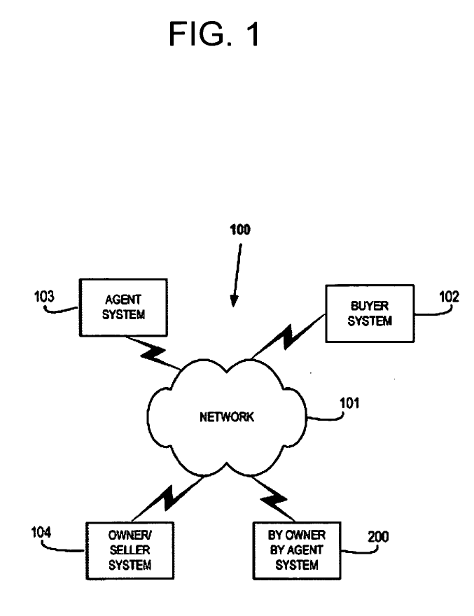

Various embodiments of the present invention may be implemented through systems and methods described in more detail below. According to one embodiment of the present invention, a network 101 allows for seemless communication between the various users of the System 200, including Agents 103, Sellers 104, and Buyers 102. With the System, Buyers, or Agents of Buyers, may access through a single screen all properties, whether listed by Agent or by Owner, according to the Buyer's selection criteria. One of ordinary skill in the art will appreciate that by providing access to multiple real estate databases through a single system, as depicted in FIG. 1, Buyers will be able to better evaluate the marketplace with respect to all homes for sale that match the Buyers' selection criteria.

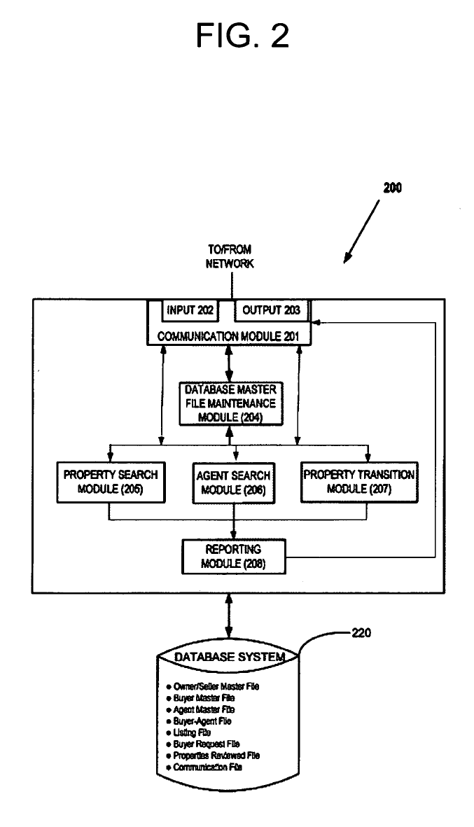

FIG. 2 depicts the various subsystems included in the System 200. In this system, communication module 201 controls requests entering the system through the input module 202 and responses to those requests being delivered via reporting module 208 through the output module 203. The database master file maintenance module allows the user to maintain information stored in the various files of database system 220. Included within the database system, for example, is a properties reviewed file, that allows Buyers to track properties that they have not only reviewed on the system, but also physically toured. After touring the property the Buyer can provide feedback to the Owner/Seller (or the Seller's Agent) pertaining to what features of the property the Buyer found of interest, what features would need to be improved before the Buyer would consider placing an offer on the property (e.g., new carpeting, new counter tops, concerned about age of furnace, priced 5% above market value, etc.). In one embodiment of the system, the Buyer may input a price below the current list price at which the Buyer would like to receive notification of a price reduction on the property. The reduction may be expressed in terms of a percentage or fixed dollar amount. The price point at which the Buyer may want to receive notification of the price reduction may, at the Buyer's discretion, be kept confidential and not shown to the Owner/Seller.

The property search module 205 allows Buyers to input all the criteria or attributes they desire in a property. These criteria could include, but are not limited to, geographic limitations, property features (e.g., number of bedrooms, number of bathrooms, etc.), minimum acreage, maximum age of property, and price range. Once input the property search module 205 will apply the selection criteria to numerous real estate databases and report the search results through reporting module 208.

According to one embodiment of the system both Sellers/Owners and Buyers may search for prospective Agents based upon the Agent's experience and specialties through Agent search module 206. Prospective Agents must have previously entered their experience and expertise. Under one embodiment the system will include a self-policing mechanism, allowing reporting of Agents that misrepresent their expertise. Once the Seller/Owner or Buyer enters the Agent search criteria, the Agent file is searched and those Agents most closely matching the selection criteria will be identified. Under one embodiment of the system, the selected Agents will be ranked based upon a scoring system that evaluates how closely the Agent matches the selection criteria. The system may be set up to automatically contact the Agents(s) selected through this process via a notification process, informing the Agent of the potential opportunity.

According to another embodiment of the system, Owners/Sellers may initially choose to list their property “By Owner.” As part of this process, the Owners/Sellers may specify a timeframe (e.g., three months), known as the “By Owner Time Period,” for which they want to list their property “By Owner.” If the Owners/Sellers do not sell their property within this timeframe, the system will automatically notify them of the expiration of the selected timeframe and give them the opportunity through property transition module 207 to convert their property from “By Owner” to “By Agent.” If desired, the system will help facilitate this transition.

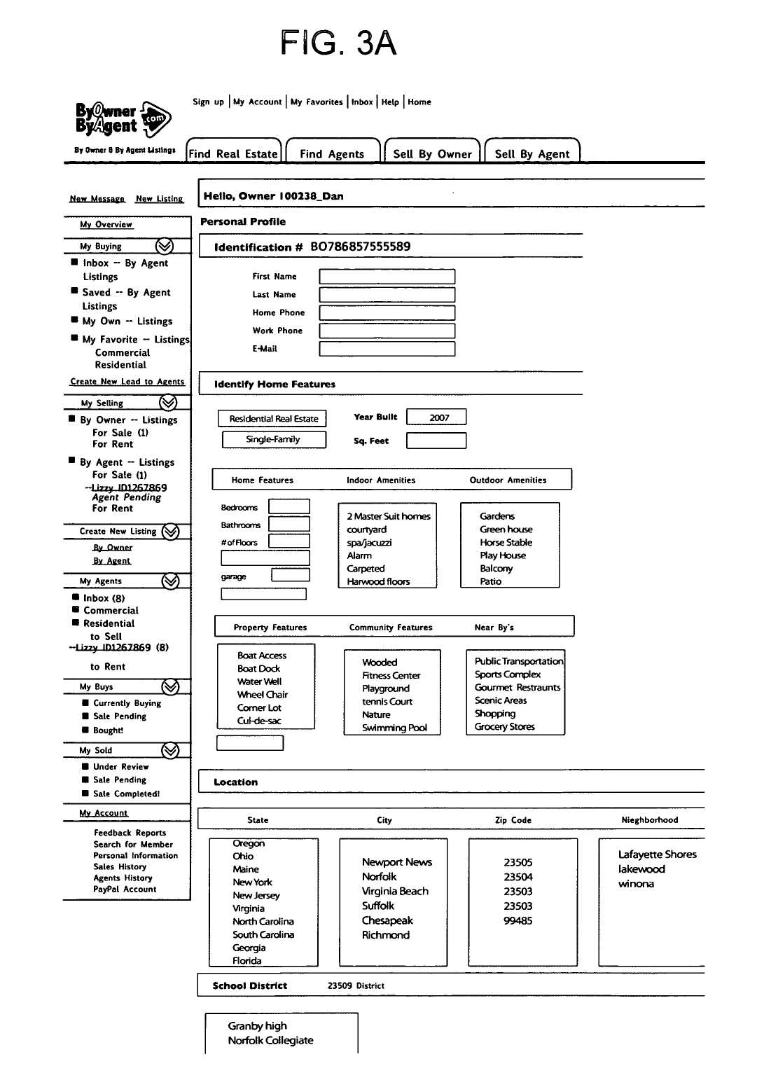

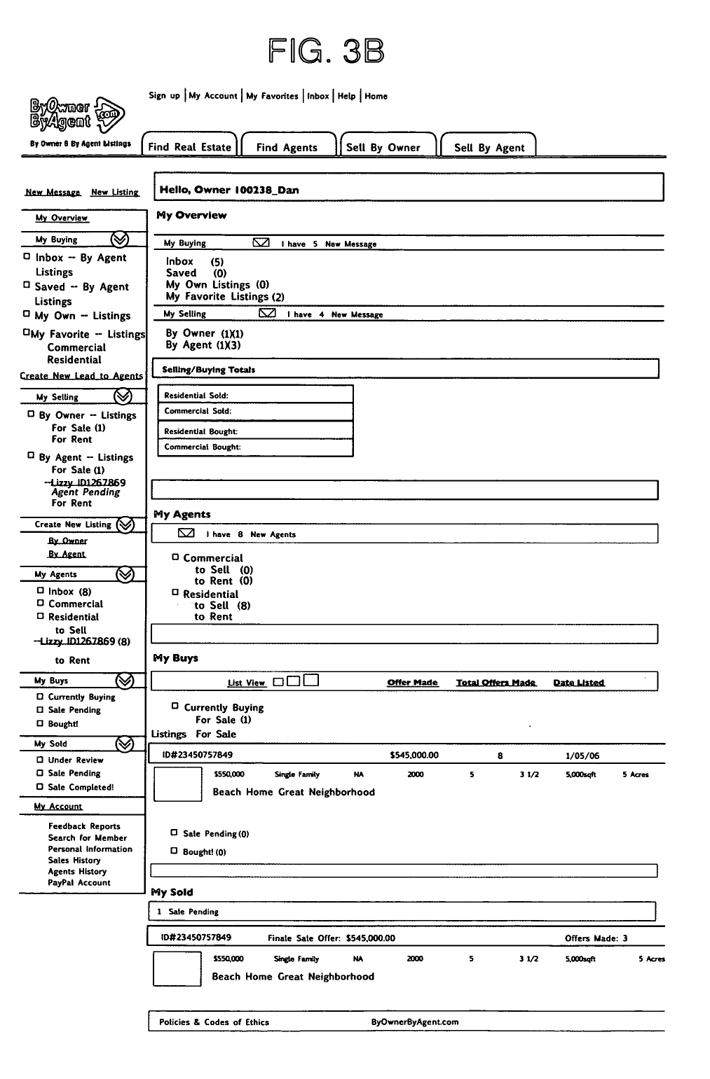

FIG. 3A depicts a screen that allows Owners to input confidential personal identification information. In addition to this personal information, Owners may also input various features or attributes pertaining to the property they have for sale. FIG. 3B depicts a summary of information for an Owner, which is maintained in the system based on the Owner's personal preferences.

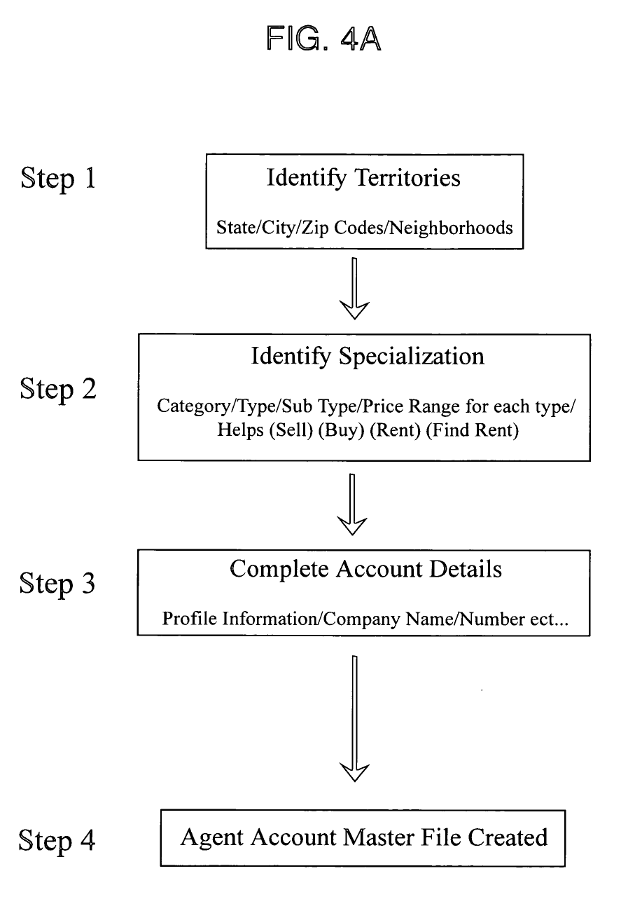

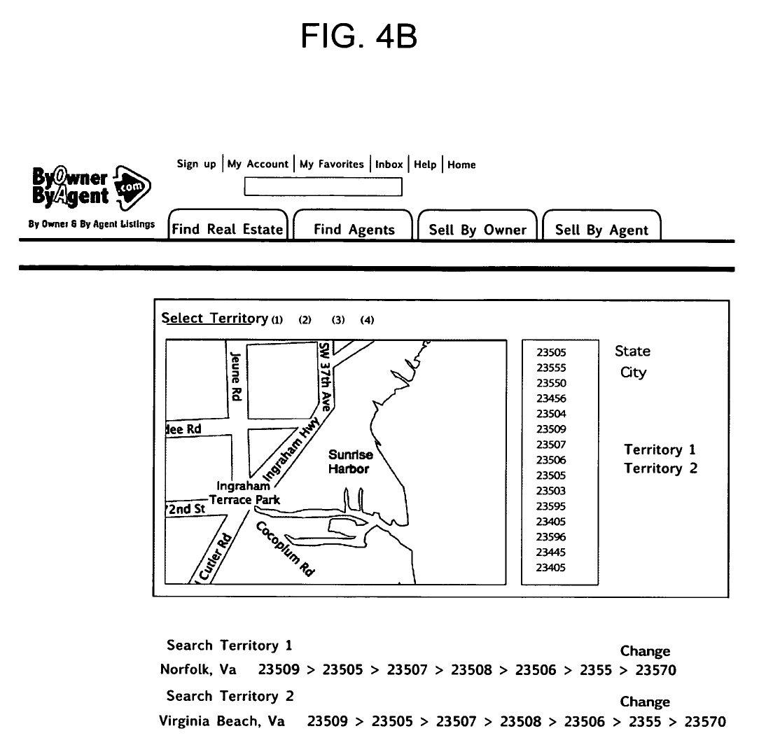

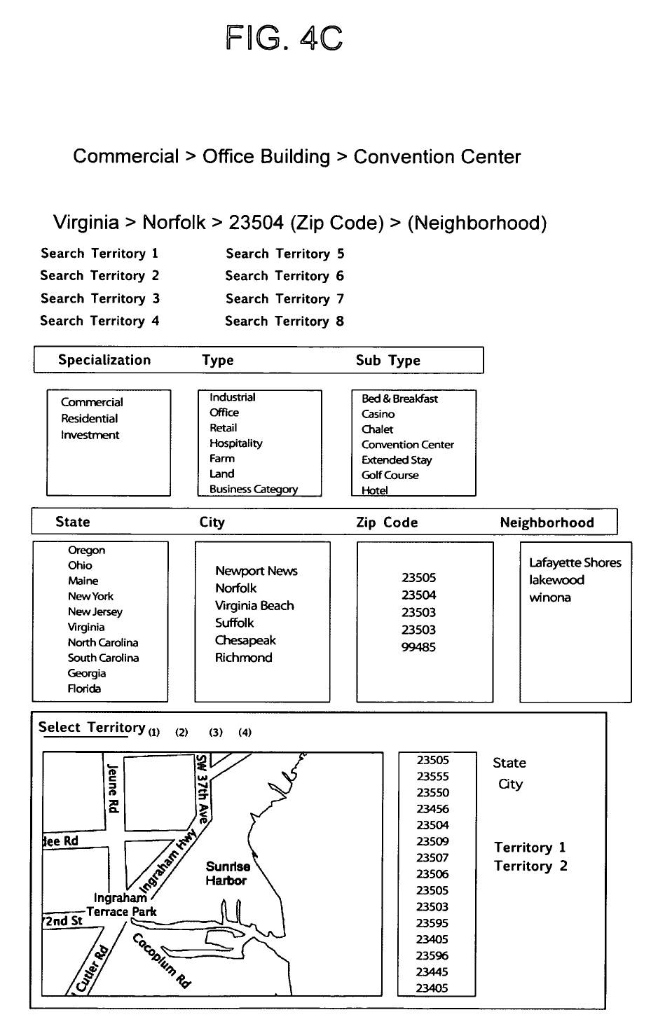

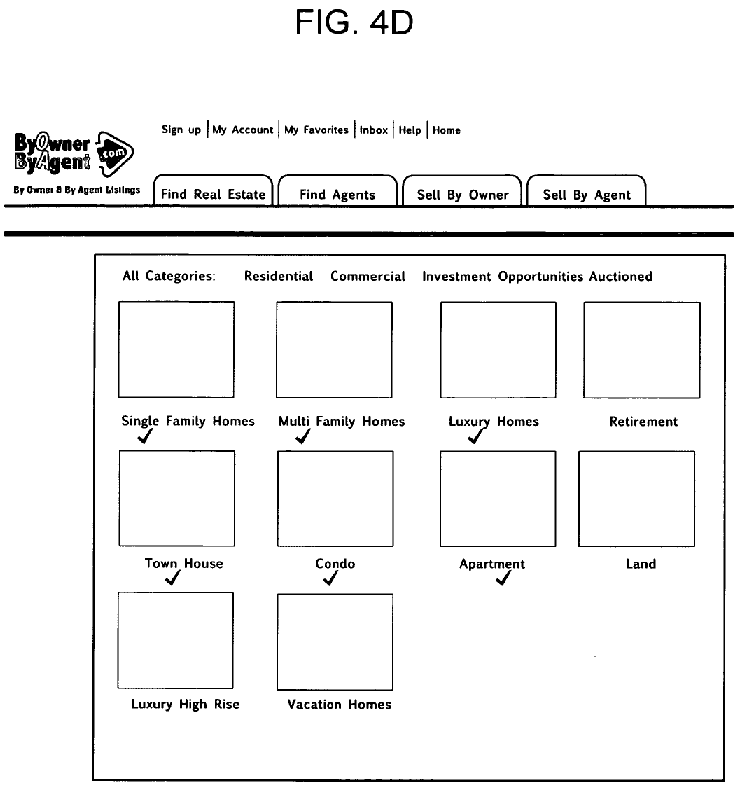

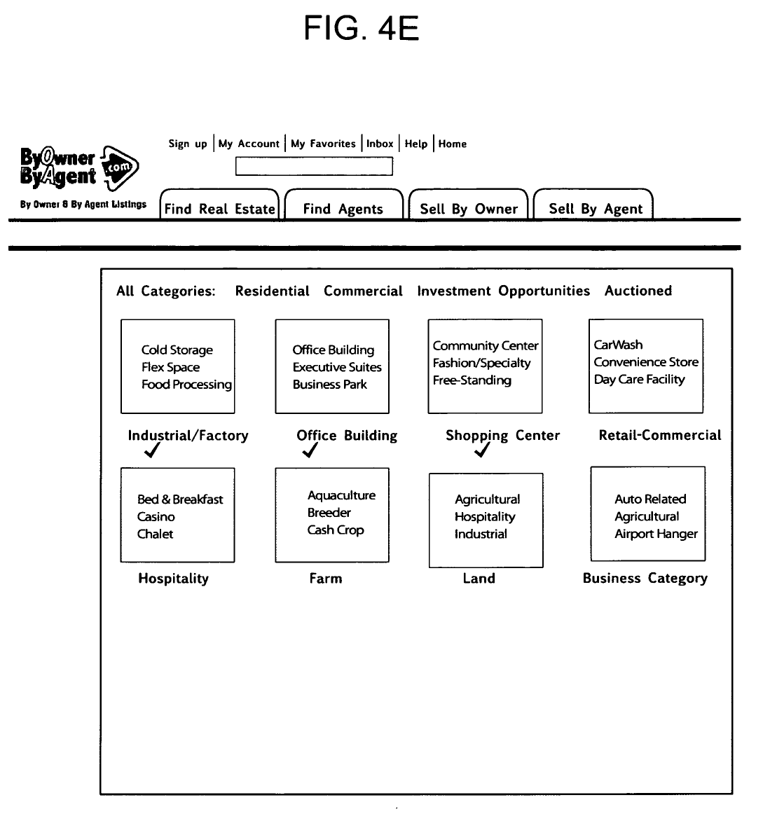

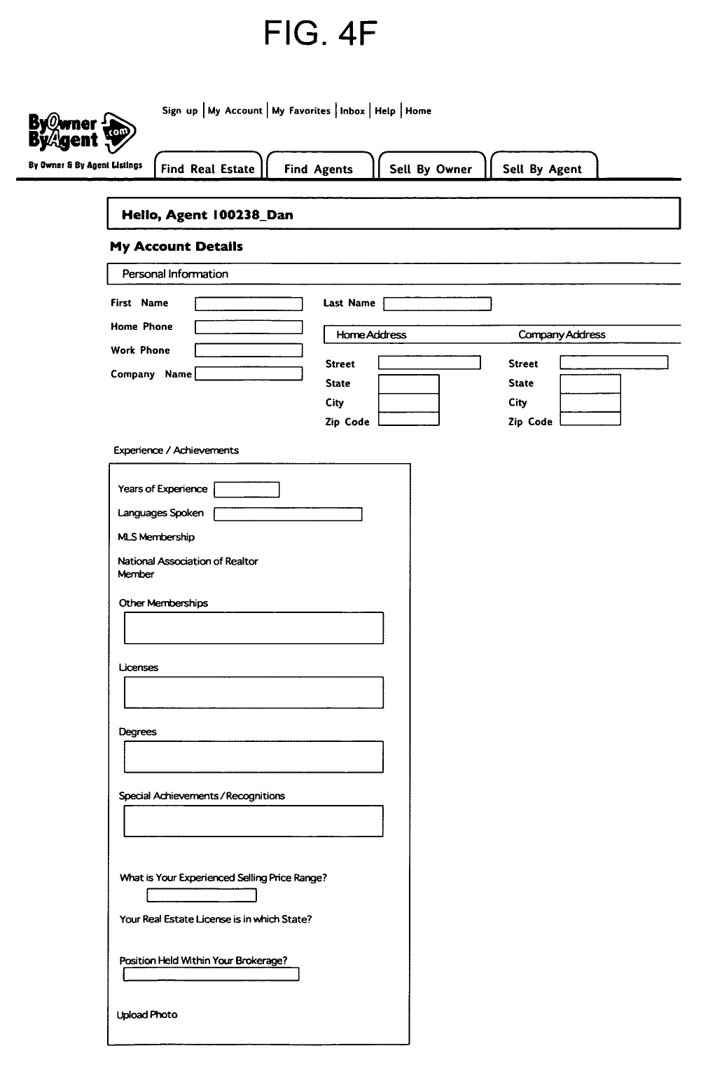

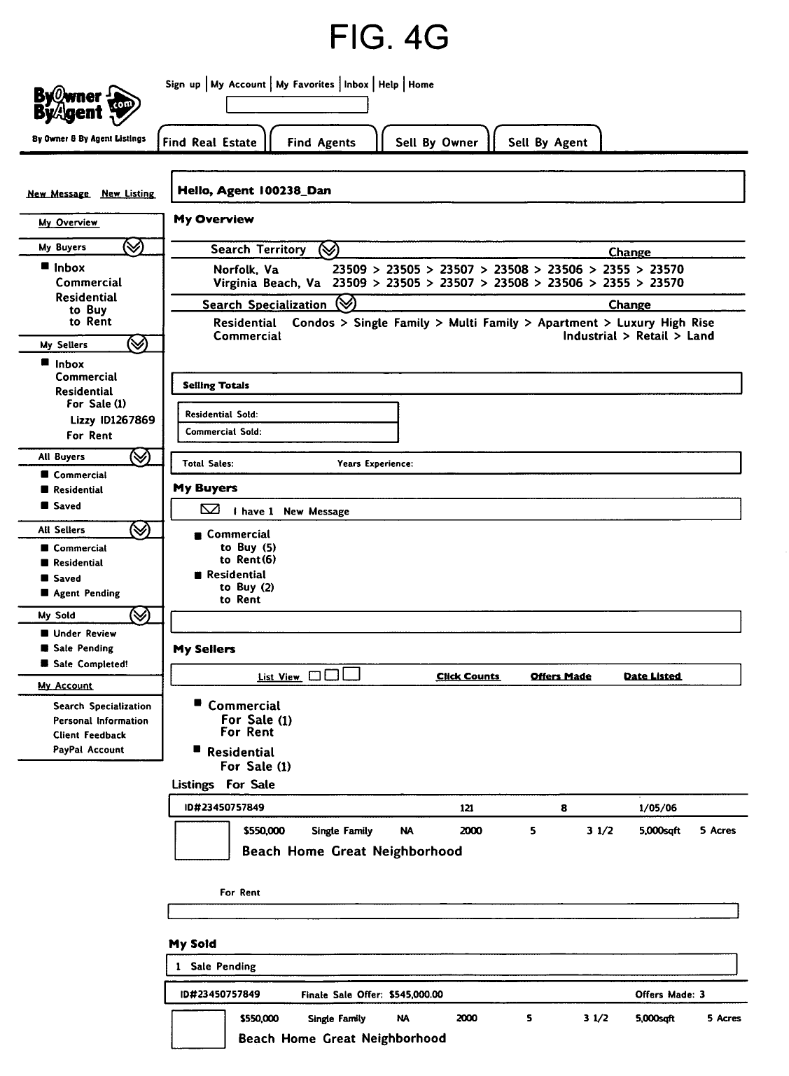

FIGS. 4A-4F depict a series of screens that allow Agents to establish and maintain their personalized profile. According to one embodiment of the system, Agents initially identify the territories in which they primarily focus, which may include specific neighborhoods in which the Agents have specialized. The Agents may also input areas of specialization, such as types of property, price ranges, etc. By entering this information, Agents assist both Buyers and Sellers that are searching through the system for potential representation. FIG. 4G depicts a summary of information for an Agent, which is maintained in the system based on the specialization data entered by the Agent.

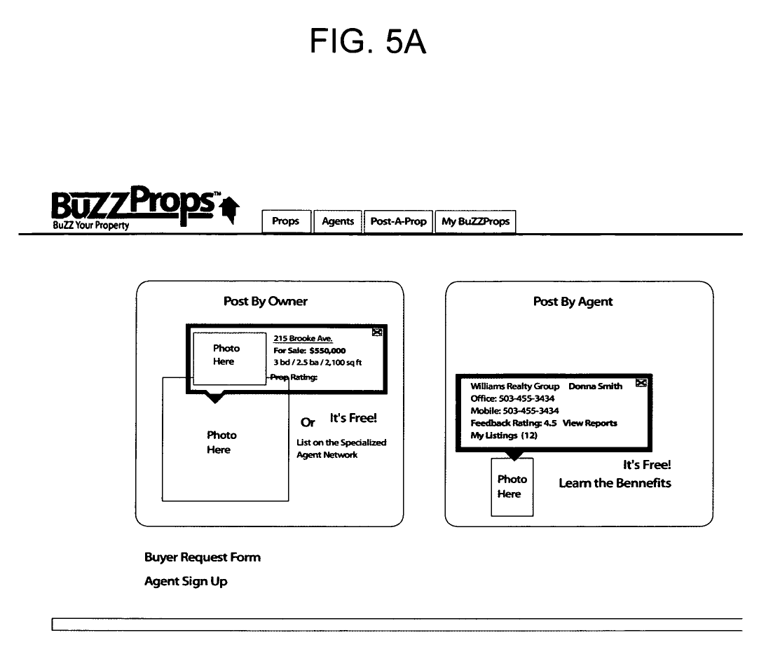

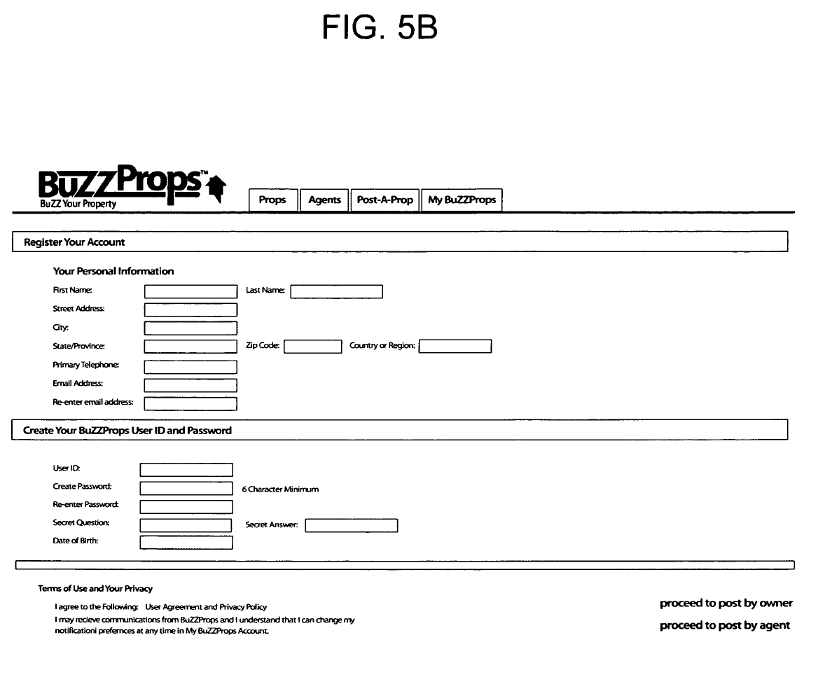

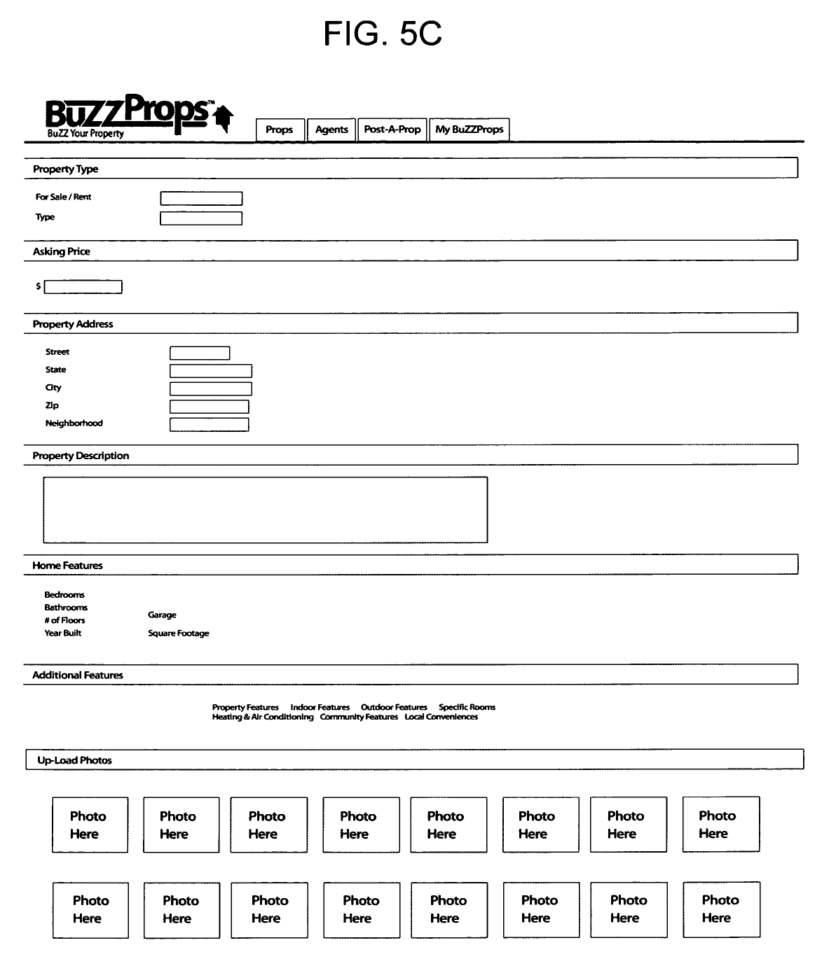

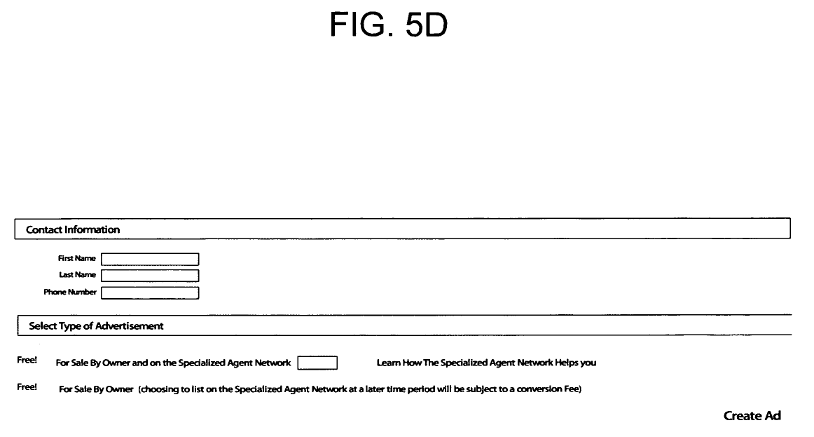

FIGS. 5A-5D depict a series of screens that give property Owners the ability to list their property “By Owner.” In one embodiment of the system, the Owner selects the desired By Owner Time Period, as well as specific details of the property for sale. In this embodiment the Owner may also agree to pay a specified commission to Agents representing Buyers. Owners also have the ability to change or maintain the commission rate and to communicate the change to all Agents that have previously inquired into the property. Owners may also choose to revise the commission rate at pre-determined intervals. Under this embodiment, Owners may initially choose to list their properties without any commission. If, however, their property does not sell over a specified timeframe, the Owner can then have the system automatically add a commission rate that the Owner is willing to pay in order to encourage Agents to show the property to their Buyers. The Owner can also specify various timeframes for the commission rate to automatically increase. In turn, Agents may choose to list only those properties upon which a commission is available. The Owner, of course, may also choose not to have the system assist in converting the property from for sale “By Owner” to “By Agent” or to automatically modify the commission rate should the property not sell within the By Owner Time Period.

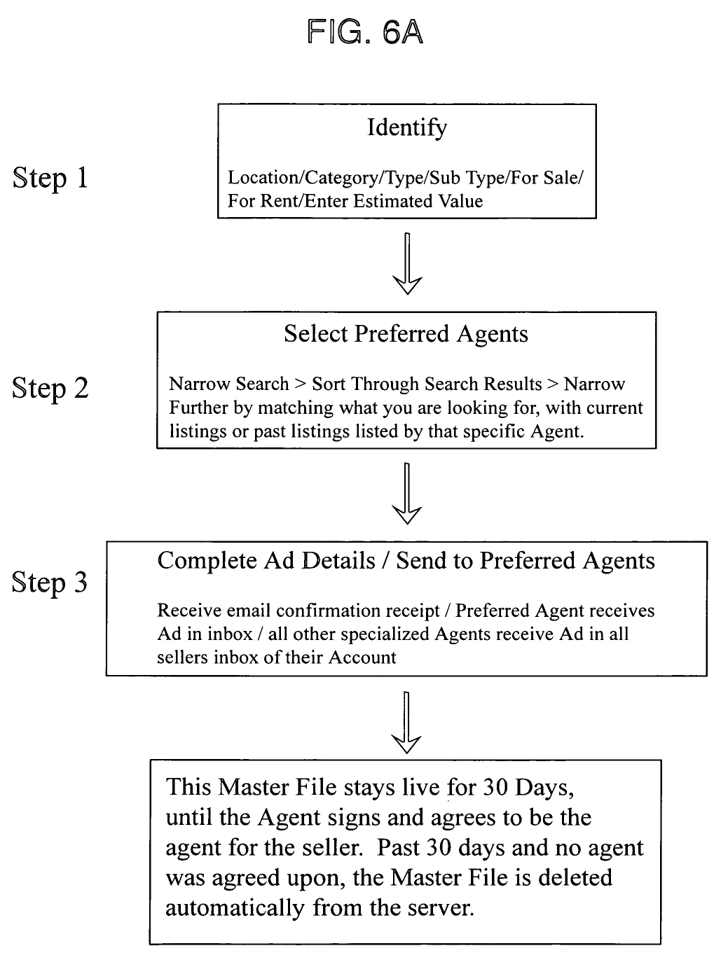

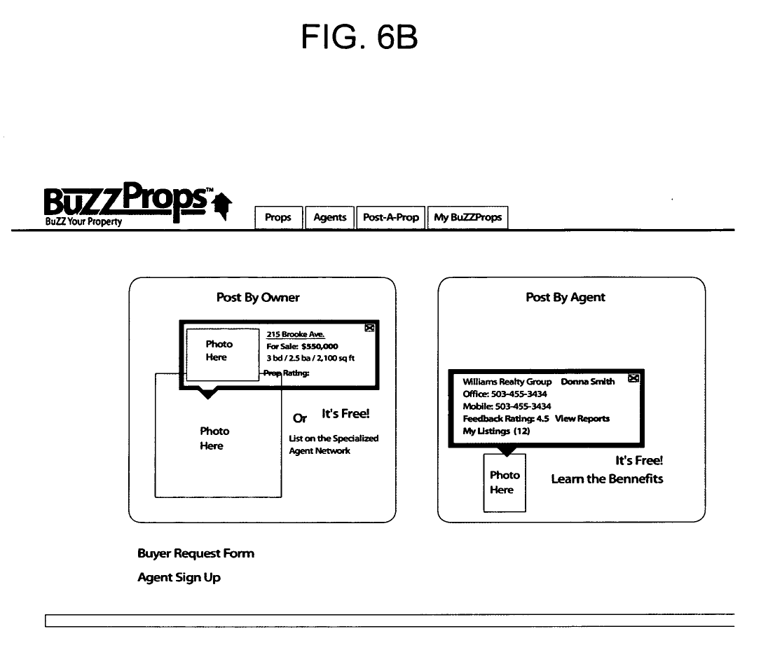

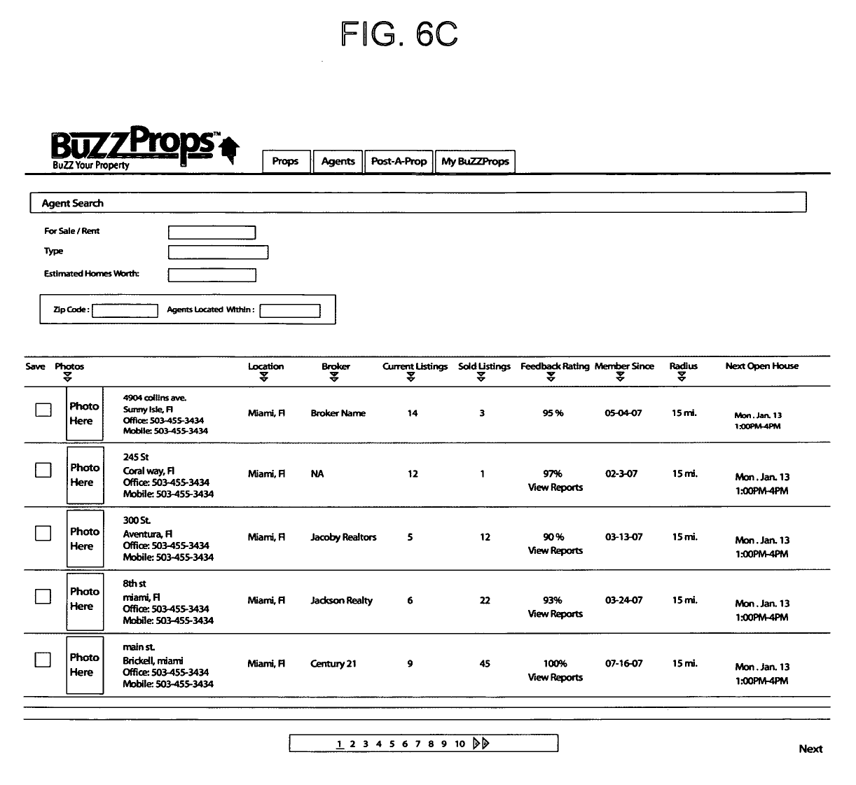

FIGS. 6A-6C depict a series of screens in which Owners may search for prospective Agents based upon desired specialization. In one embodiment the Owners receive a listing of all the Agents that satisfy the Owners' selection criteria. The Owners may then review the detailed Agent profile, which includes the Agent's experience and expertise. The Owners may then choose through the system what Agent(s) the Owners want to contact in order to gain more information concerning potential representation. Owners may interview prospective Agents through the system electronically as part of the selection process. Once the Owner selects a specific Agent, the Owner may then automatically transfer information concerning the Owner's property to the selected Agent. The system also allows the Agent to confirm representation to the Owner.

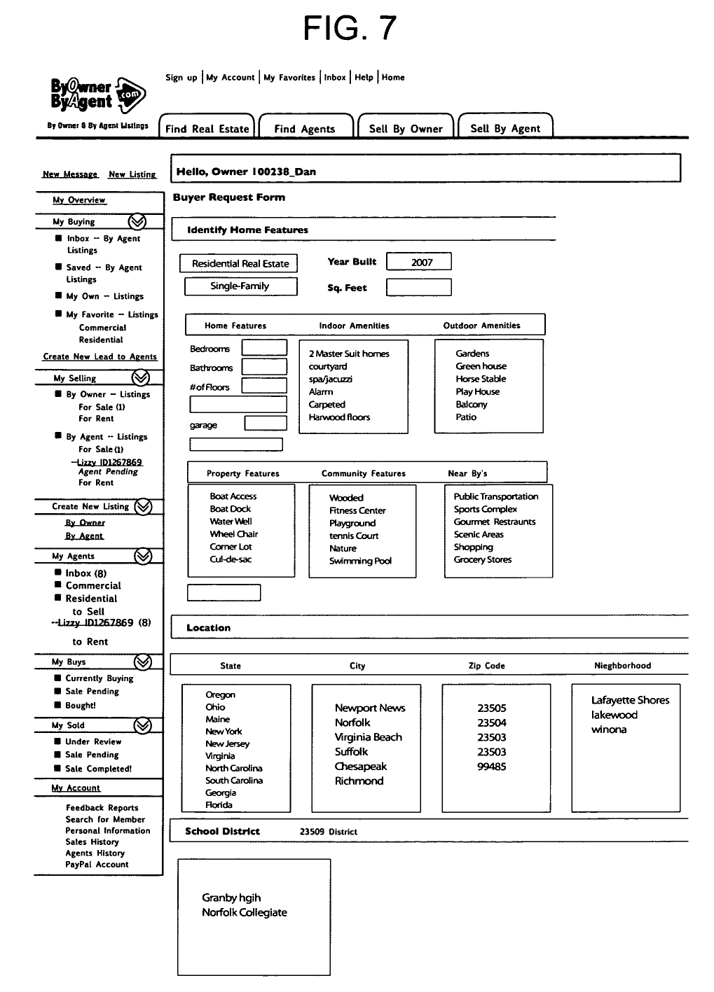

FIG. 7 depicts a screen that allows Buyers to enter certain selection criteria regarding the type of property the Buyer is interested in potentially purchasing. Once the selection criteria is entered, the system queries a plurality of real estate databases and presents the Buyer with a complete list of qualifying properties. Under one embodiment of the system, the Buyer may keep online notes pertaining to each selected property, thereby allowing the Buyer to keep track of properties reviewed and reasons why a specific property may or may not be of interest.

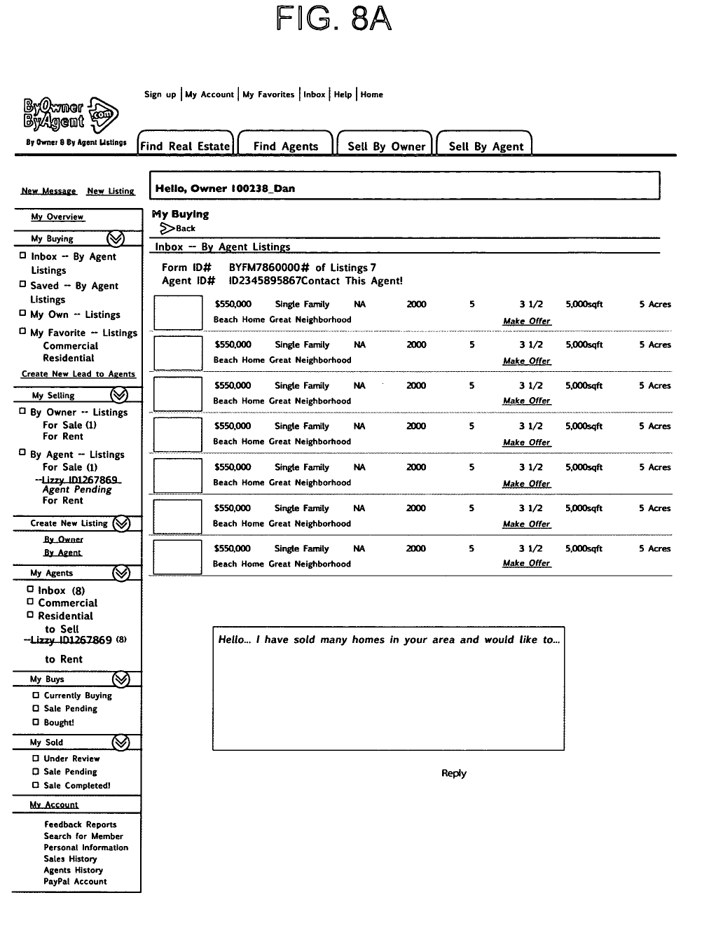

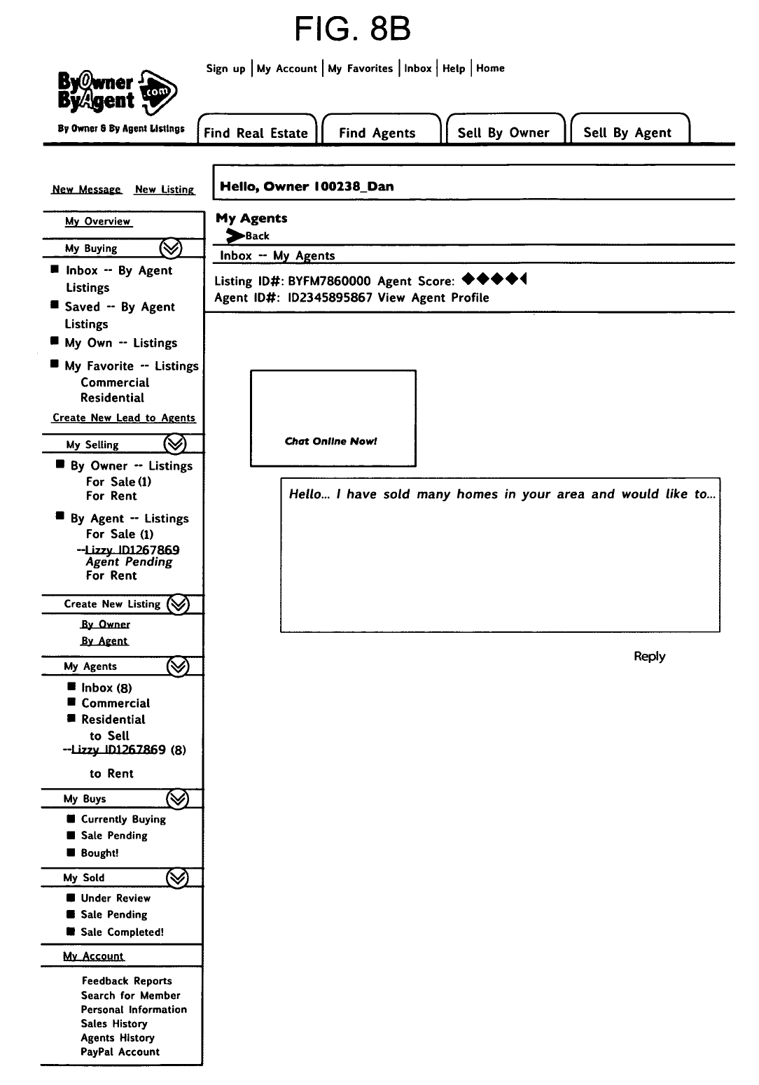

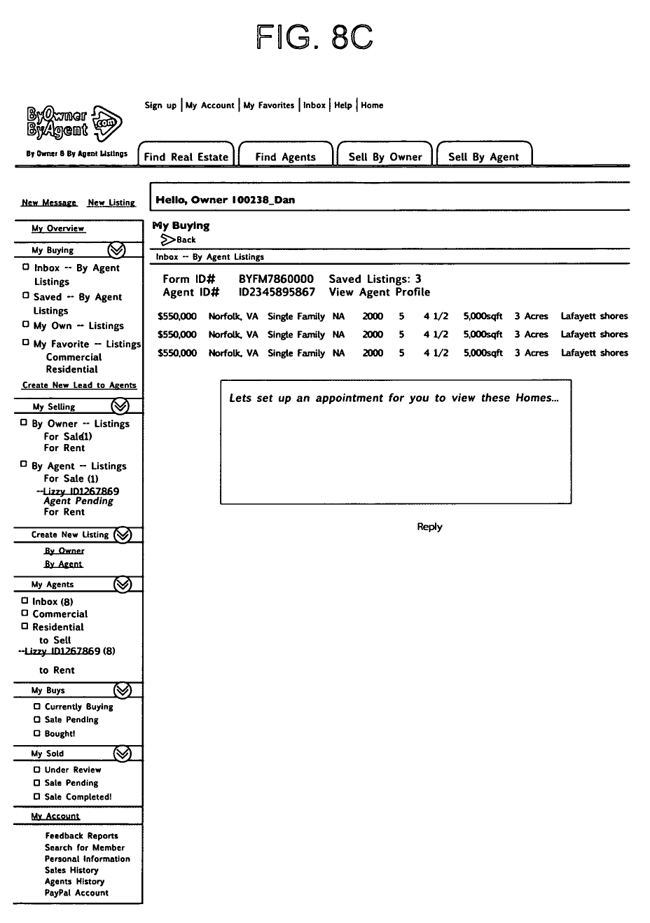

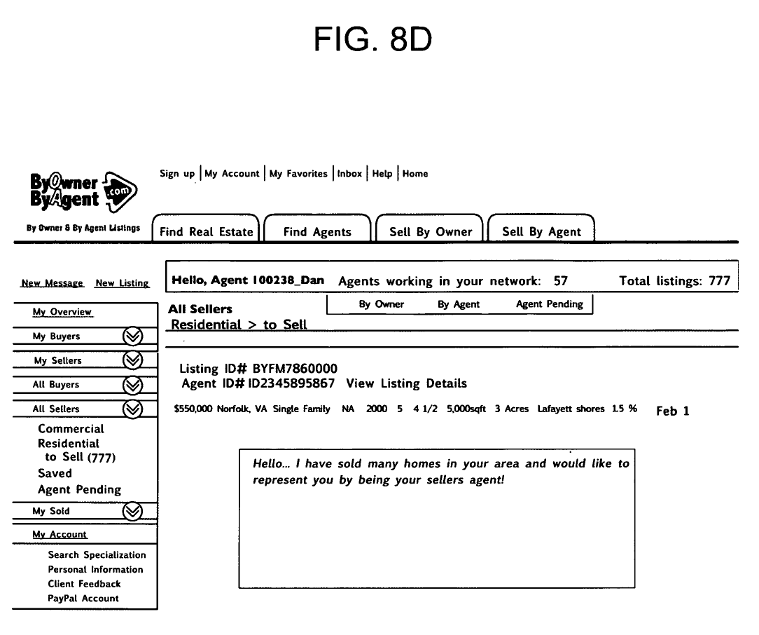

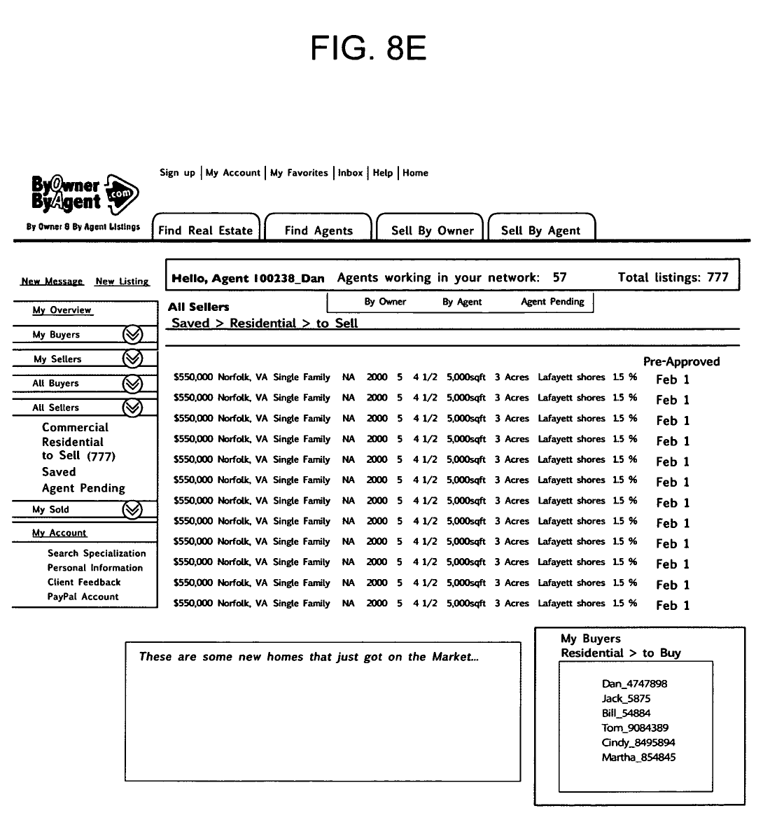

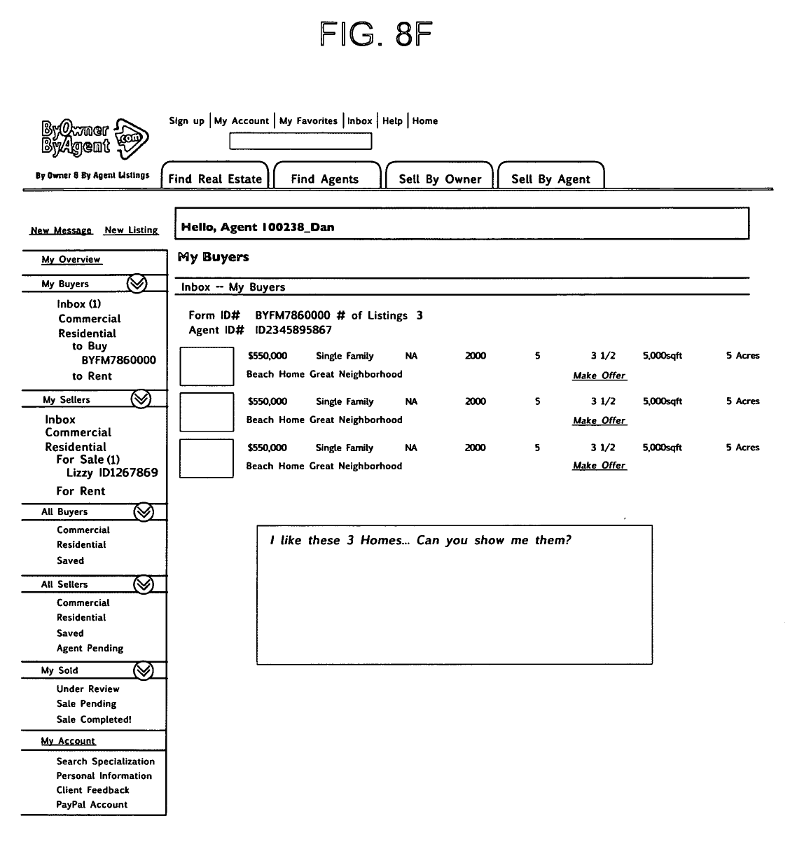

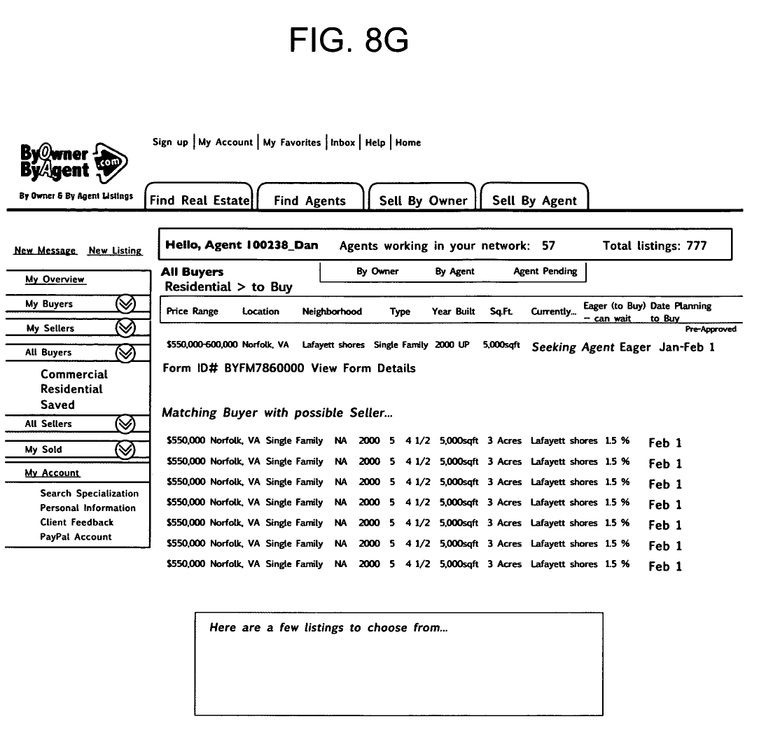

FIGS. 8A-8G depict a series of screens associated with Communication Module 201, which provides system users with the ability to communicate with each other. For example, Agents may communicate with property Owners regarding the status of the listing, the results of recent tours through the property, etc. One of ordinary skill in the art will appreciate the numerous levels of communication that can occur between the users of the system based on the functionality of this embodiment.

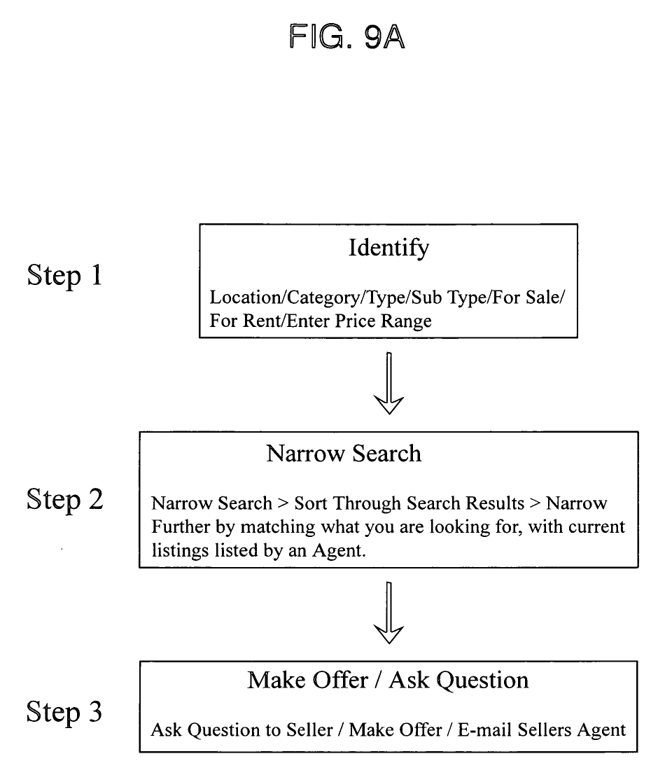

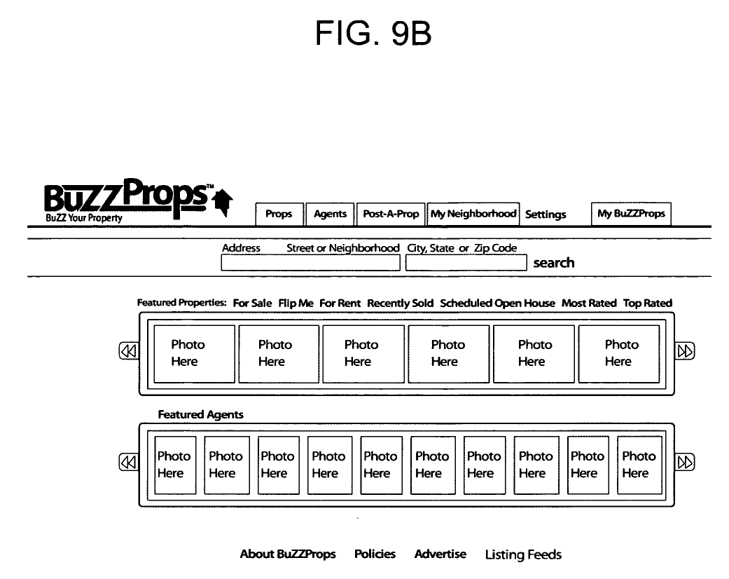

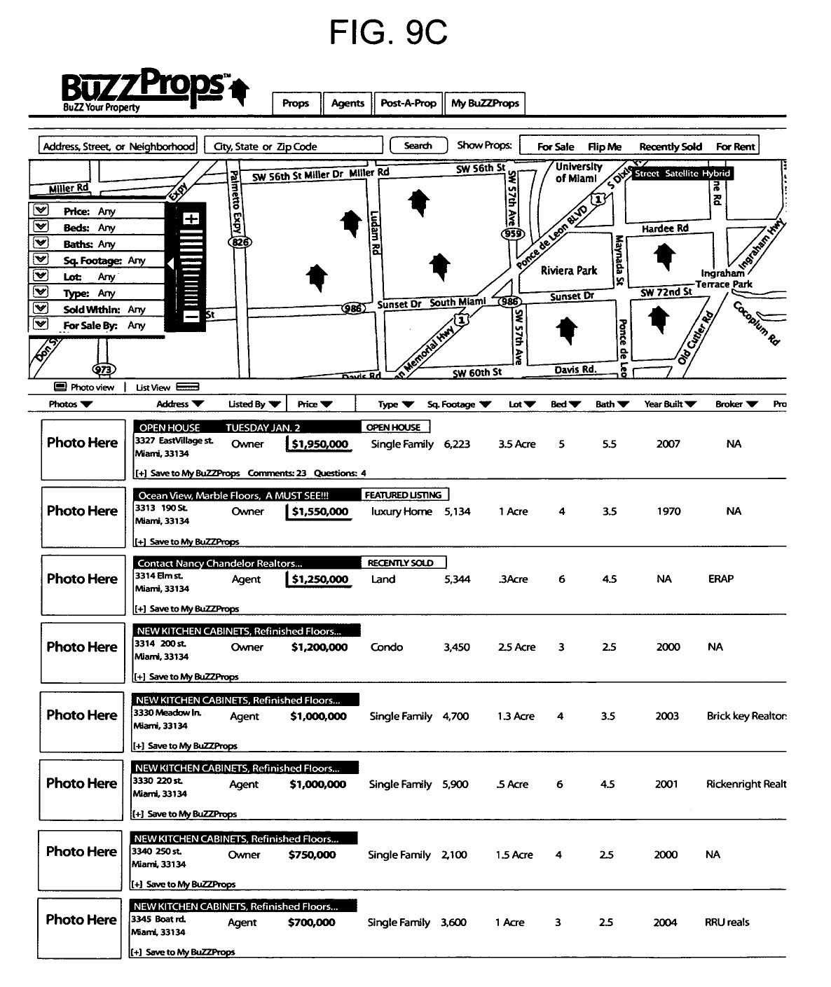

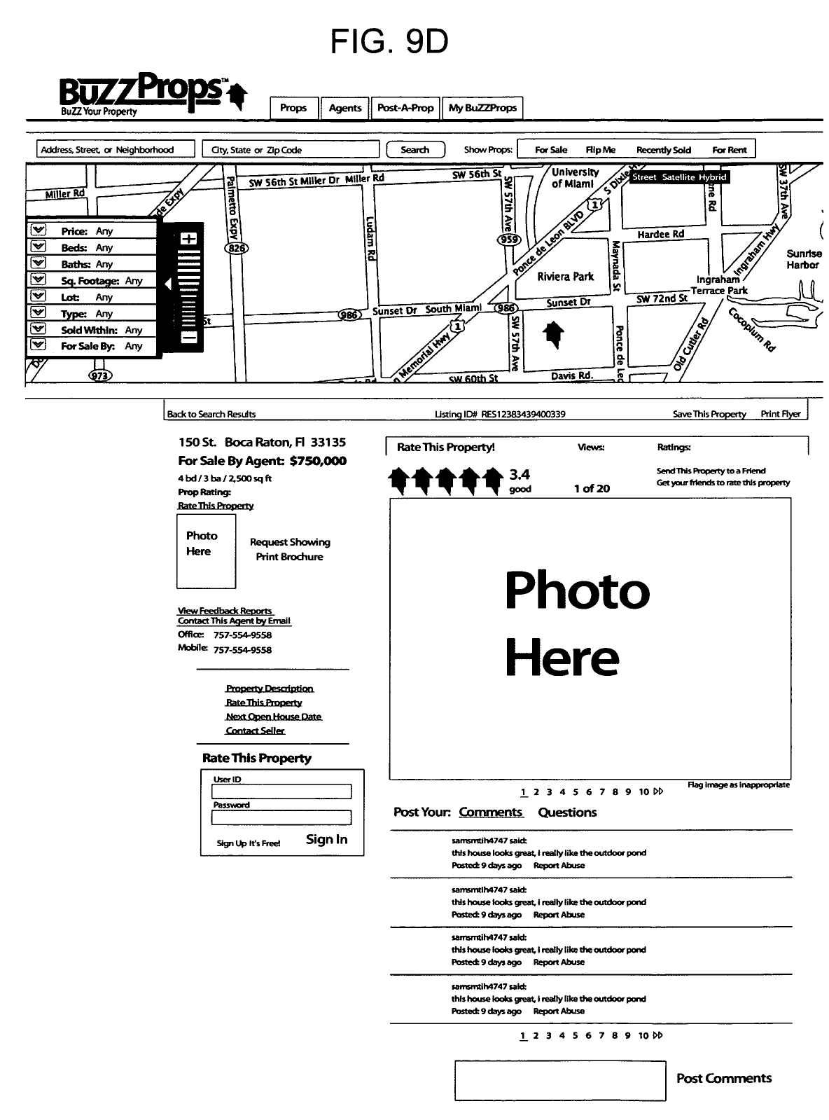

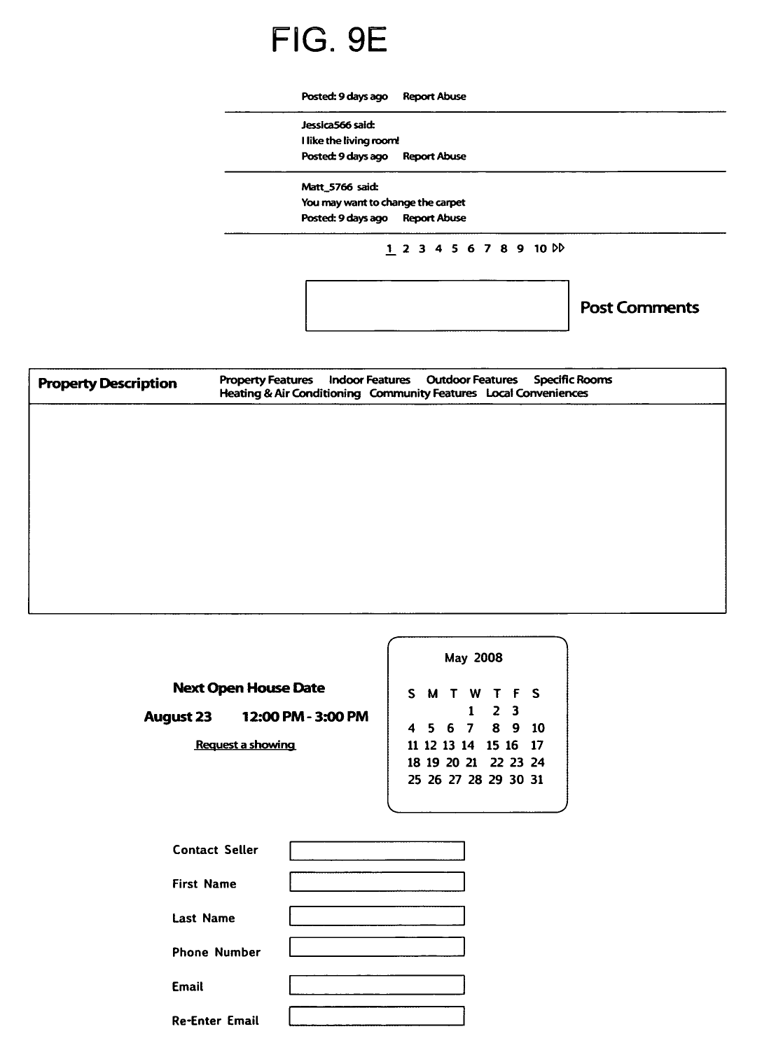

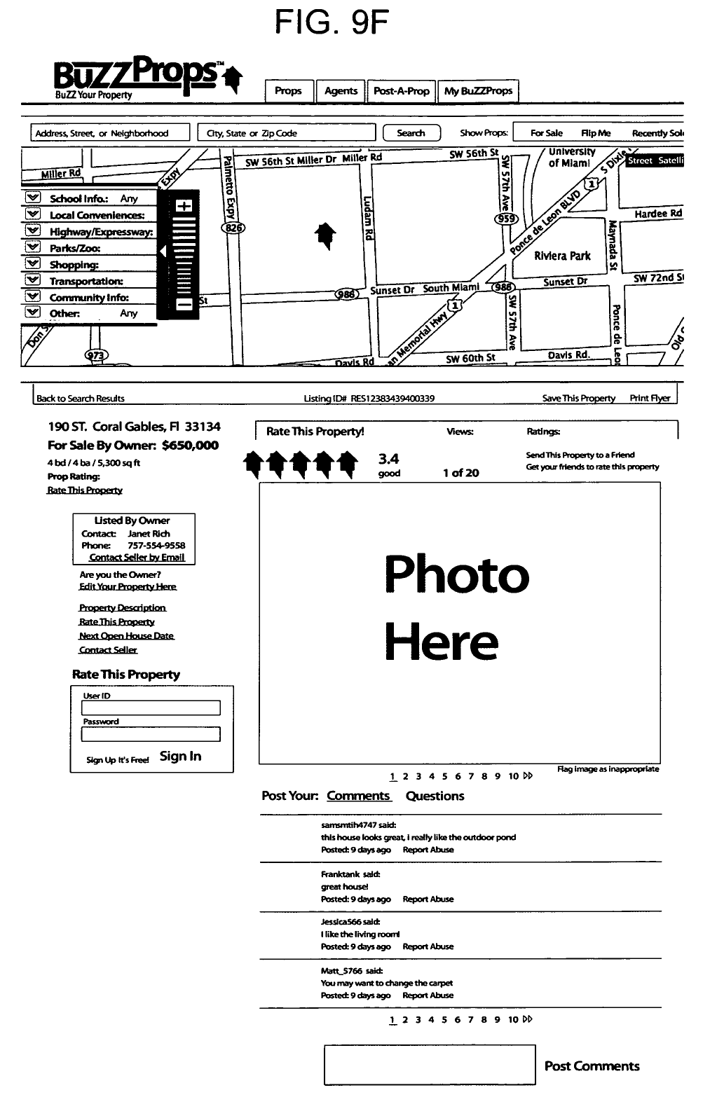

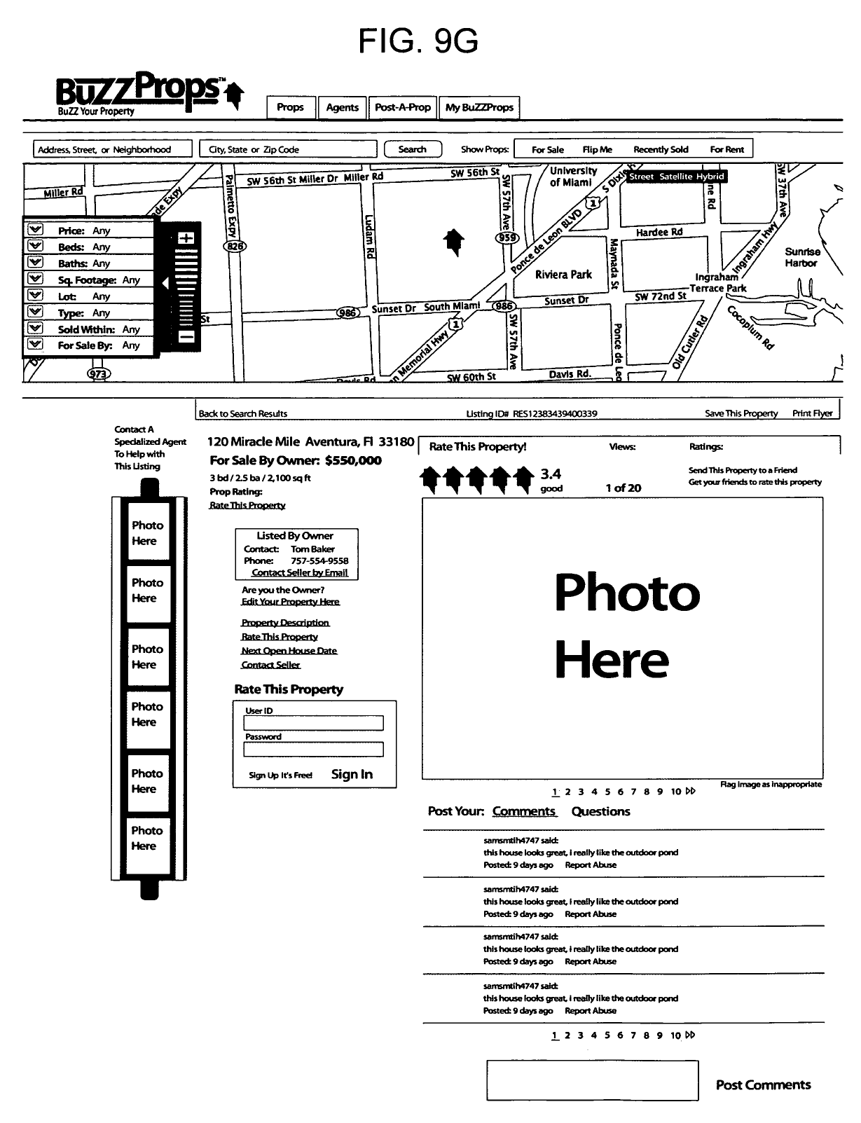

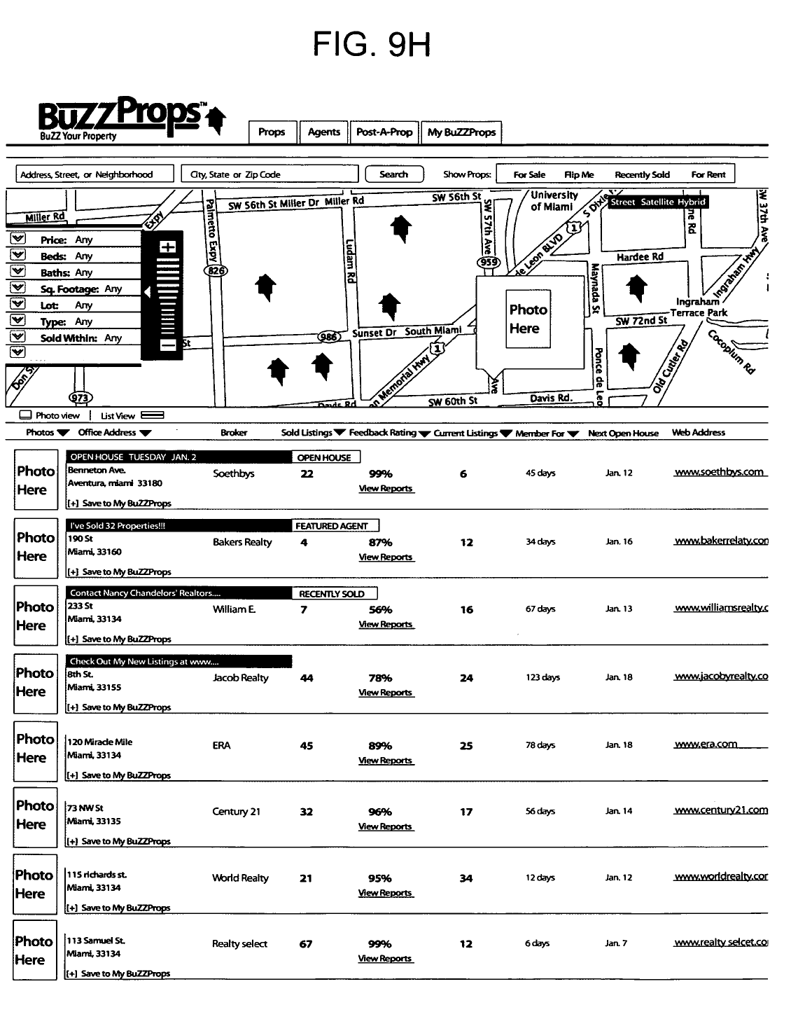

FIGS. 9A-9H depict a series of screens that allow both Agents and Buyers to enter property selection criteria and then search for properties matching that criteria. As the search process is often iterative in nature, the selection criteria may be broadened if too few a number of properties are identified or the selection criteria may be narrowed if too many potential properties are identified. Under one embodiment of the system Buyers are permitted to enter questions and comments regarding a property, which are then communicated to the Owner (or the Owner's Agent). The Owner (or Owner's Agent) may then respond to the Buyer's inquiry. The system also contains a scheduling function allowing tours of the property to be electronically scheduled, as well as the display of future open houses. Once a property is toured, the prospective Buyer or Buyer's Agent may enter comments concerning the property. For example, if the prospective Buyer is interested in the property, but believes the property is currently priced too high, the Buyer may confidentially enter a lower price for the property. If the Seller later lowers the property price to a price at or below the Buyer's lower price, the system will notify the Buyer of this price reduction.

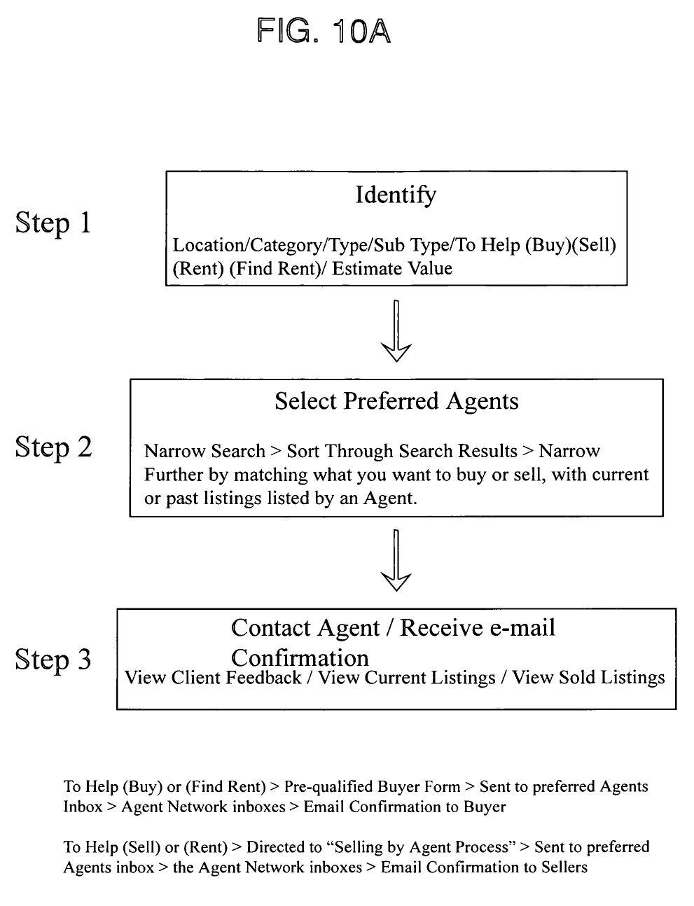

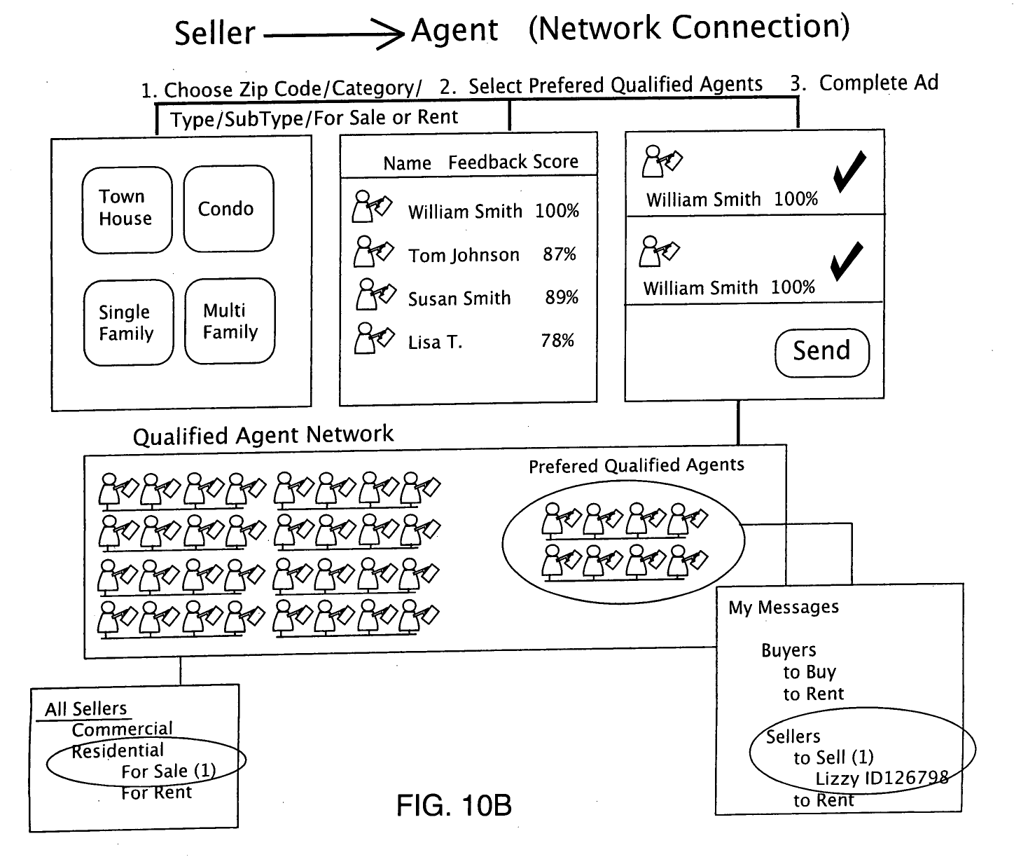

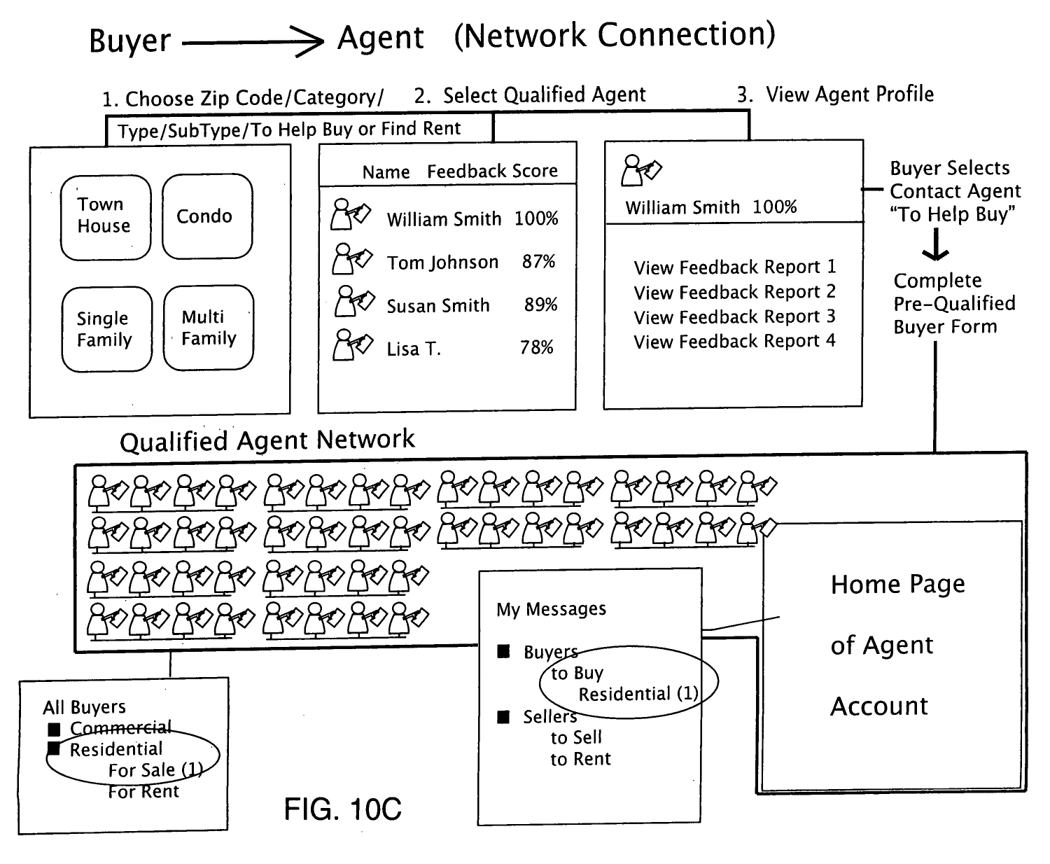

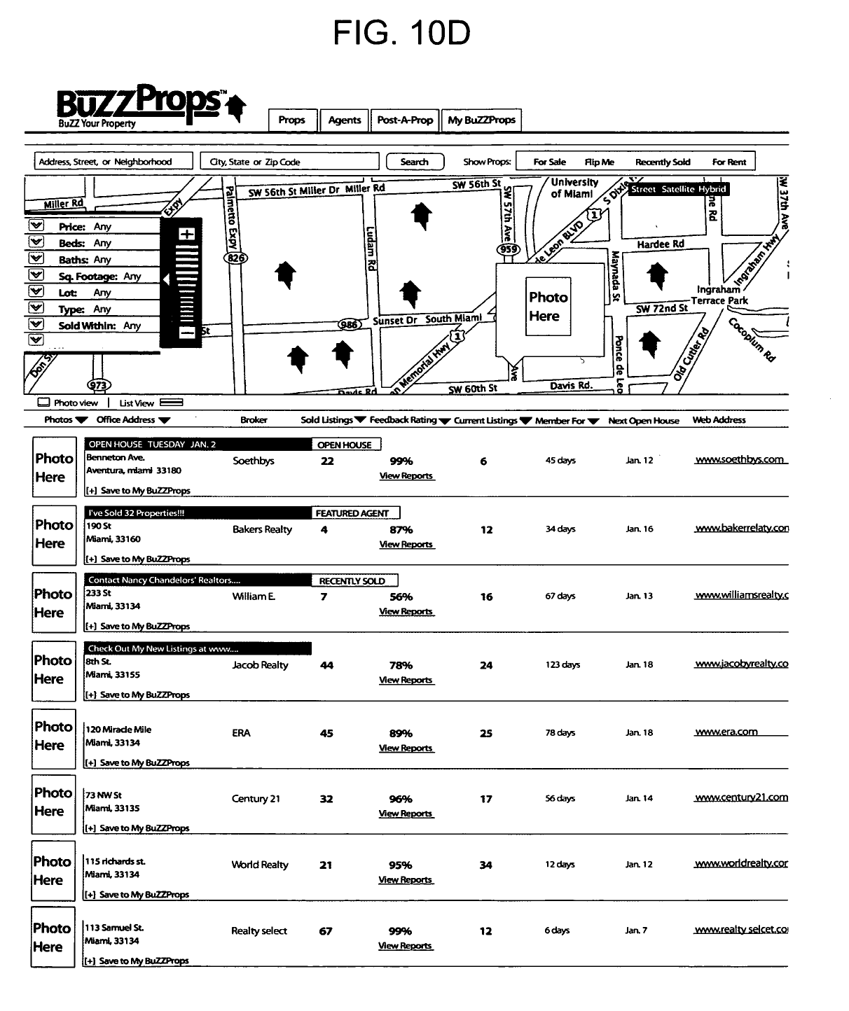

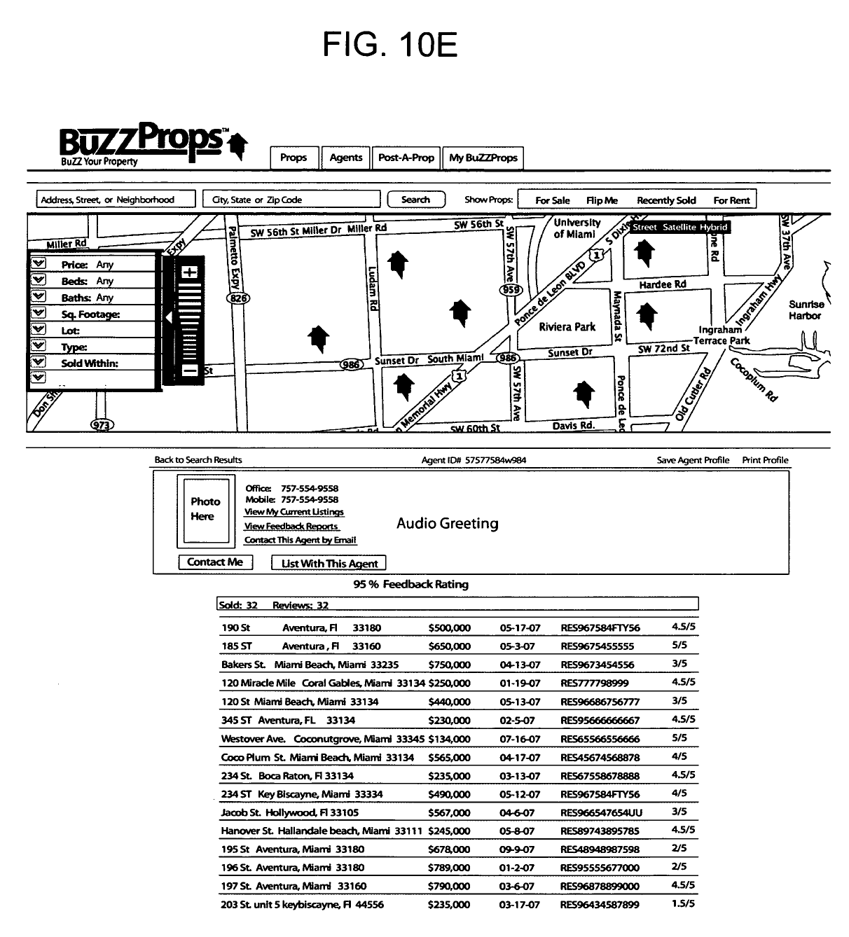

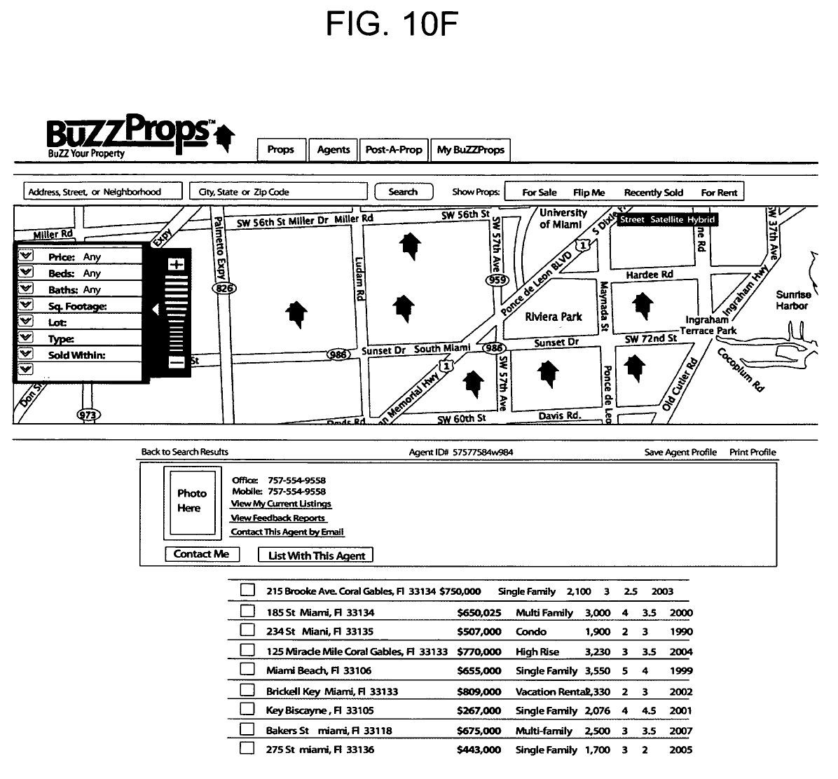

FIGS. 10A-10F depict a series of screens representing another embodiment of the system in which Buyers or Sellers may search for Agent representation. In this embodiment Buyers and Sellers may review feedback concerning an Agent that has been entered by others that have employed that Agent's services. Further, each Agent will through time develop a rating or score based on the Agent's customer service levels, which is presented on the system. With respect to the Agent's property listings, Sellers will be able to see exactly how long each listed home was on the market, averages for time on the market by neighborhood, and the Agent's total average time to sell a home. Sellers will also be able to see how many properties the Agent has listed and sold during a specified timeframe within a specified geographic territory (e.g., within two miles of the Seller's property). Further, Buyers and Sellers may communicate with prospective Agents electronically through the system, allowing all parties to more efficiently use their time.

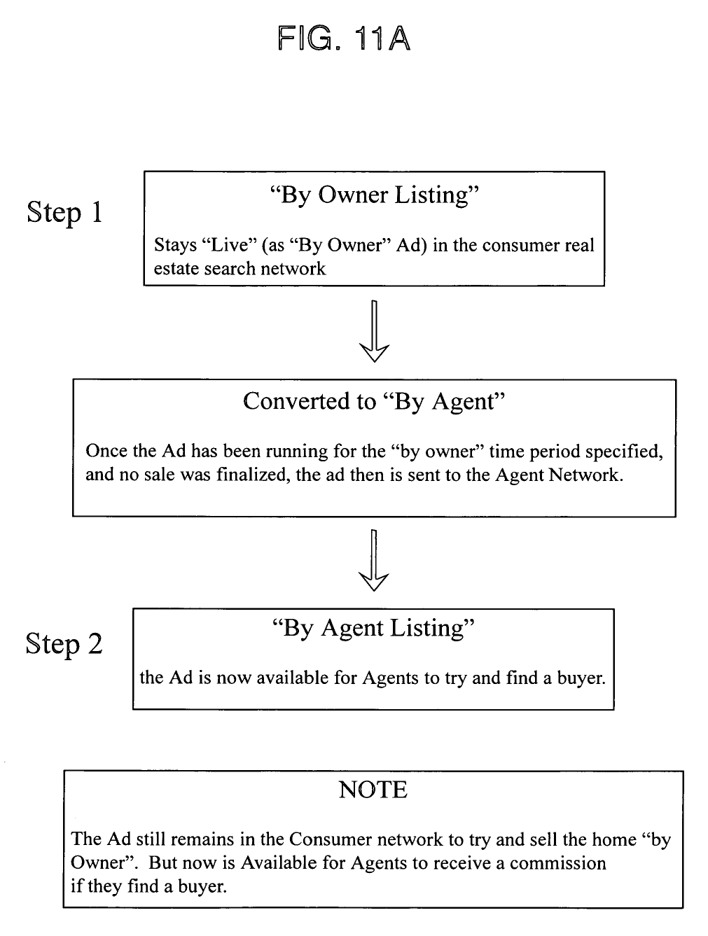

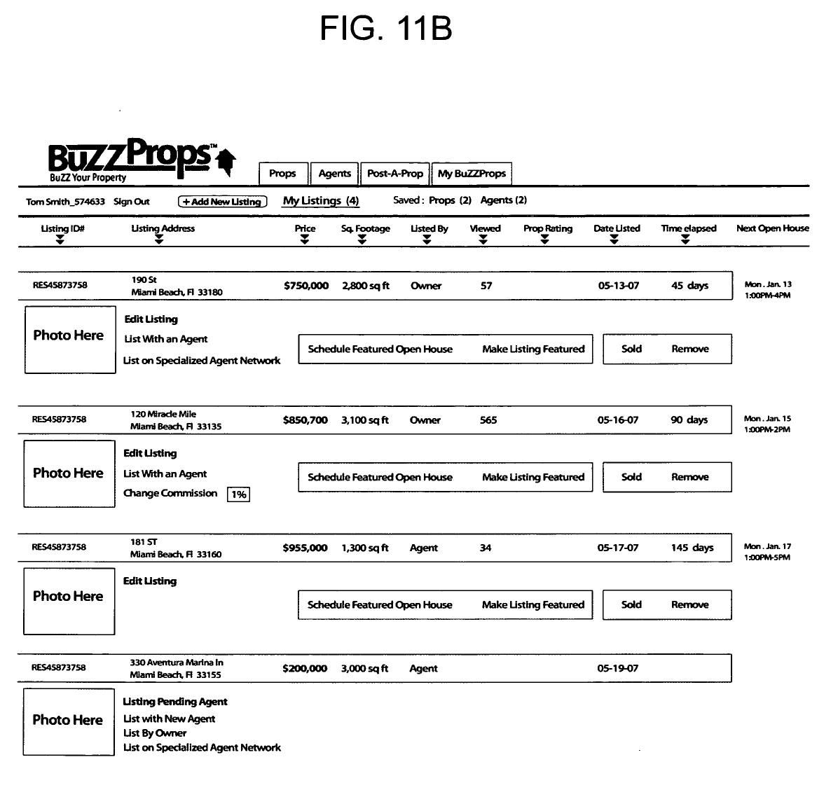

FIGS. 11A-11B depict the process and corresponding screen outlining the process by which a property originally listed “By Owner” is converted into a property listed “By Agent.” This transition process is within the complete control of the Owner. By providing an automated method of converting a property from “By Owner” to “By Agent,” enormous efficiencies are experienced by both the Owner and the Agent.

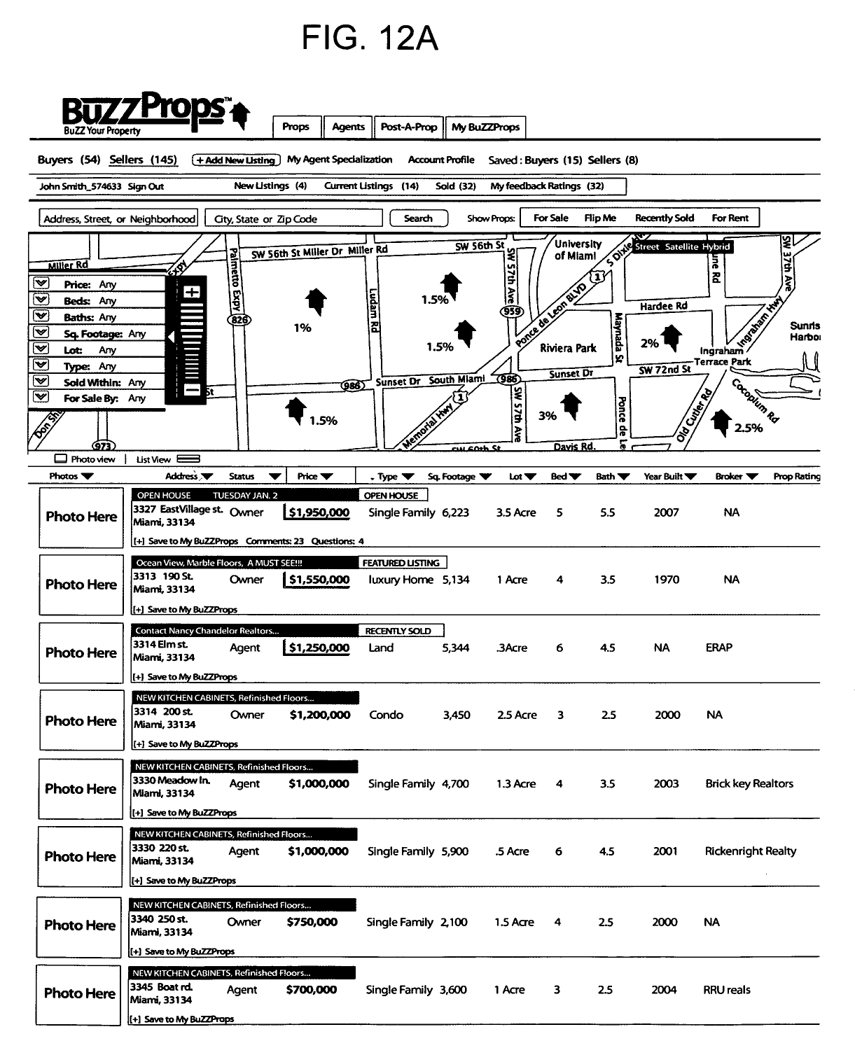

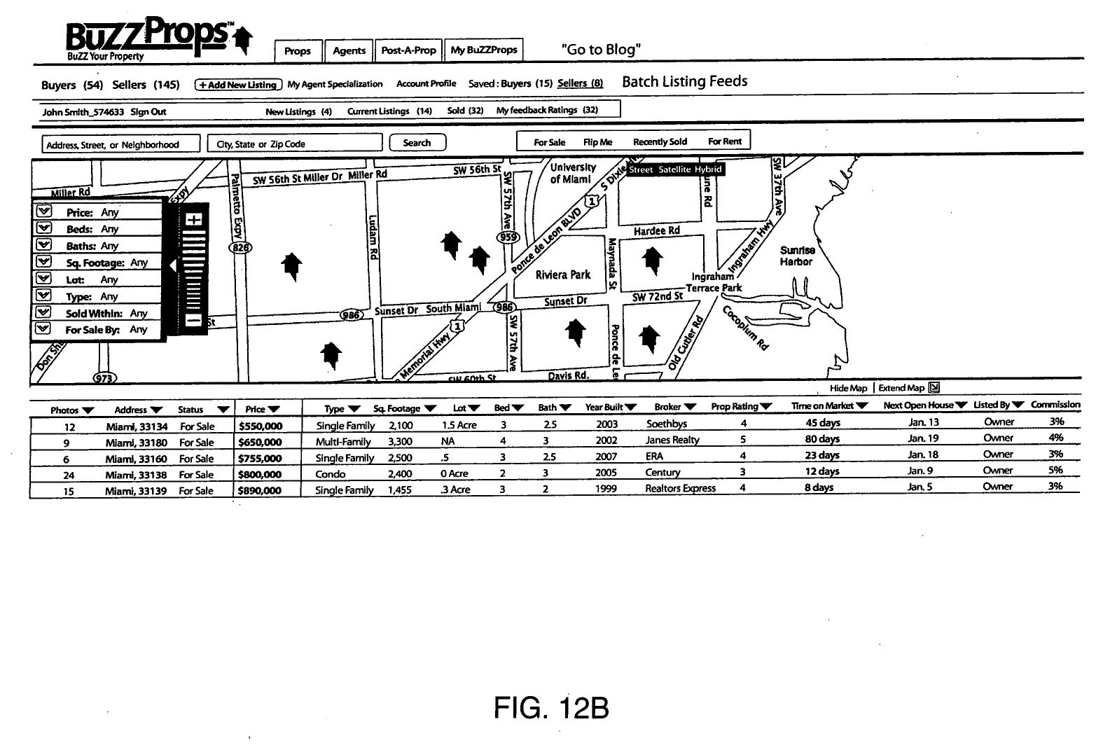

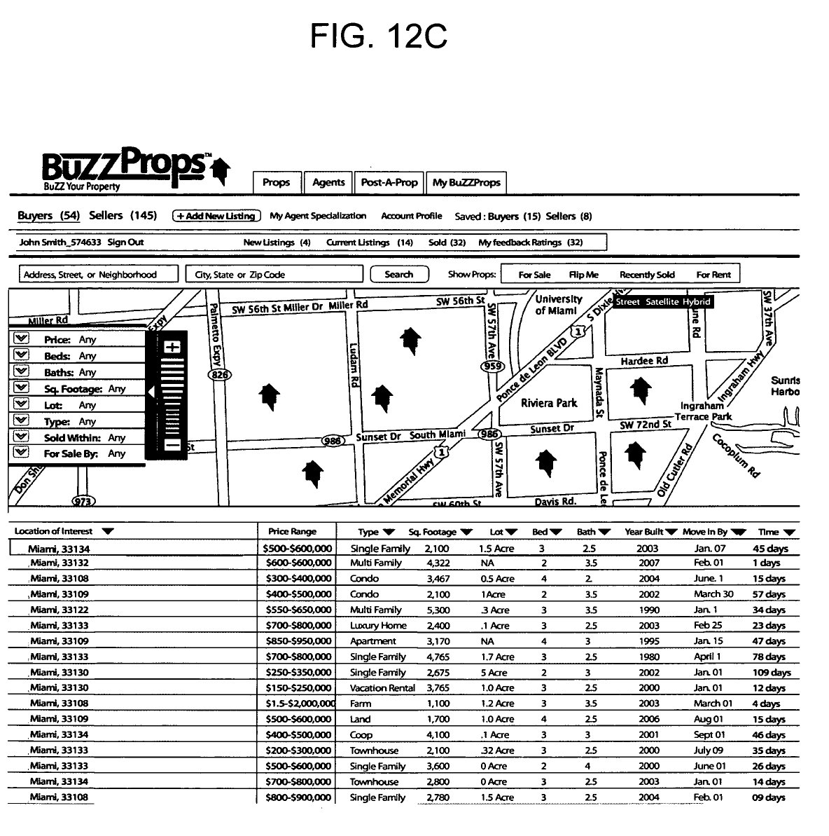

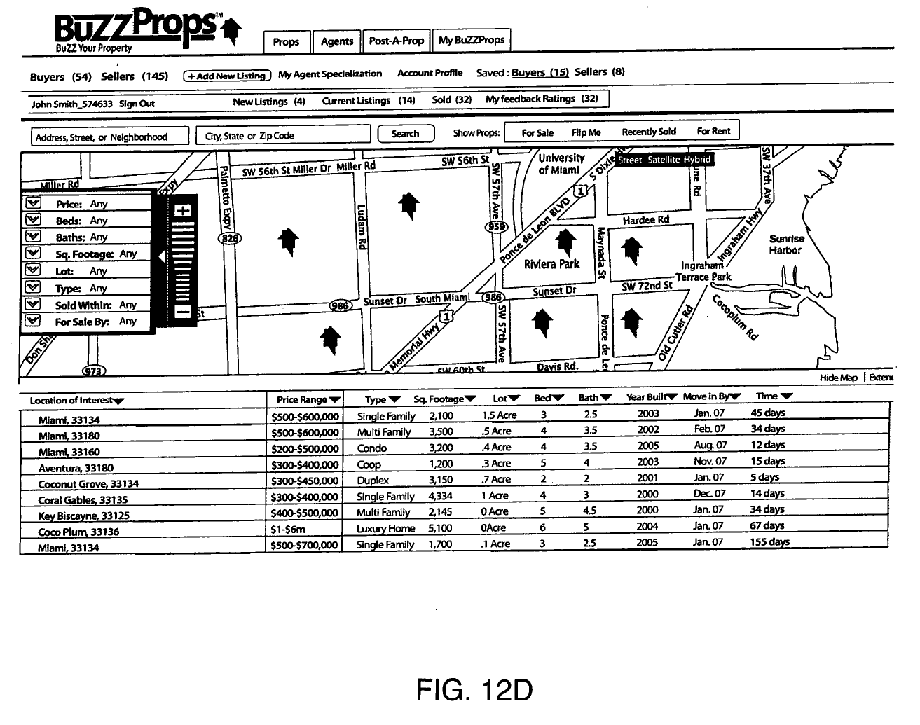

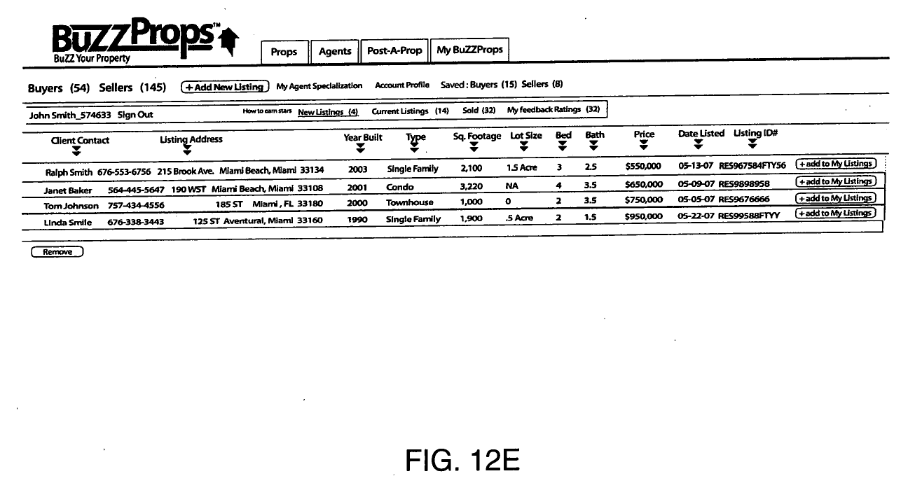

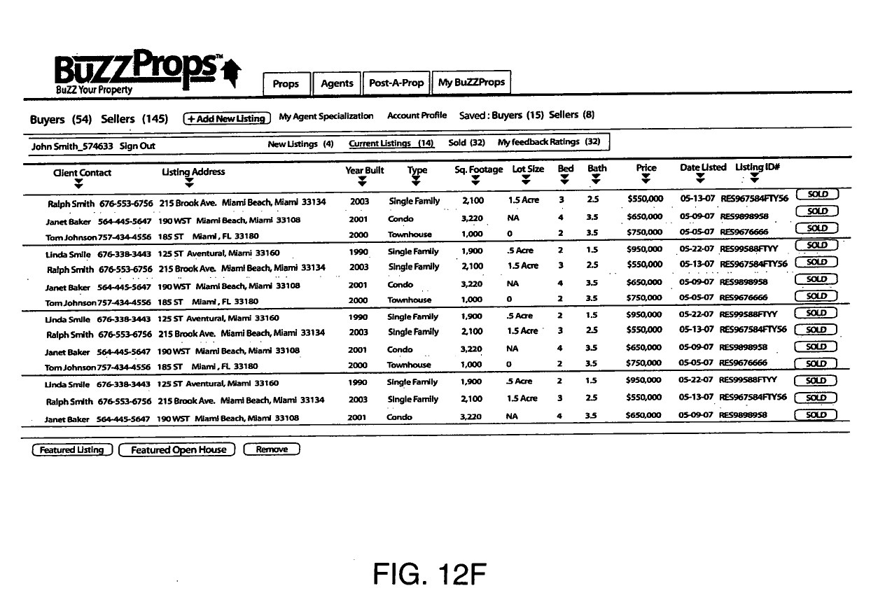

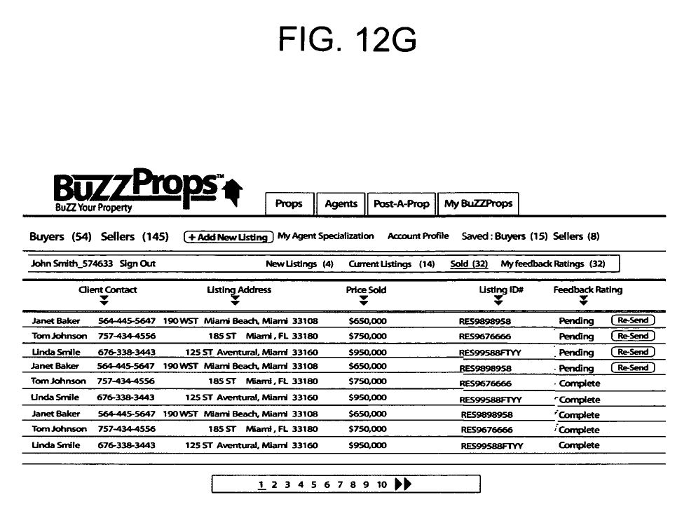

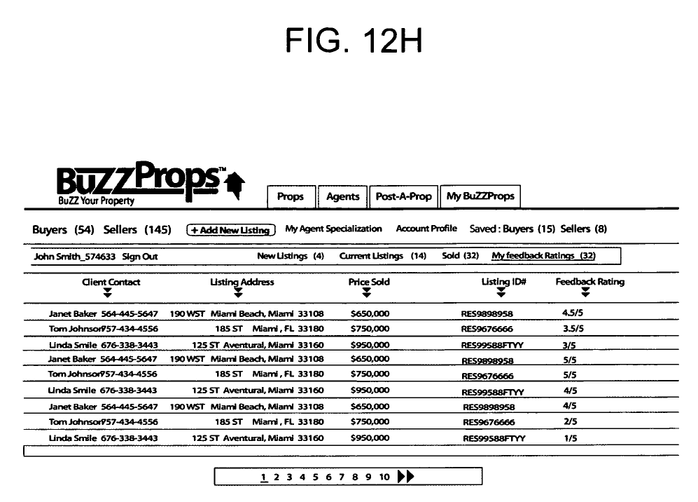

FIGS. 12A-12H depict a series of screens providing system users with access to a wide range of information based on the user's needs. Each user, however, is permitted to access only the information that is proprietary to that user or that another user of the system has granted access. For example, a Seller (or Seller's Agent) may be permitted to see both positive and negative feedback regarding the property from prospective Buyers. By receiving information of this nature, Sellers will be able to adjust their selling approach in a much more efficient manner.

In one embodiment of the system, summary screens are available that allow Sellers, Buyers and Agents to receive summarized information pertaining to the specific user's information maintained on the system. For example, an Agent may view the status of all the Agent's Buyers, properties listed, etc One of ordinary skill in the art will readily appreciate the number of summary screens that are available based on the data not only maintained in the system, but also available through other databases.

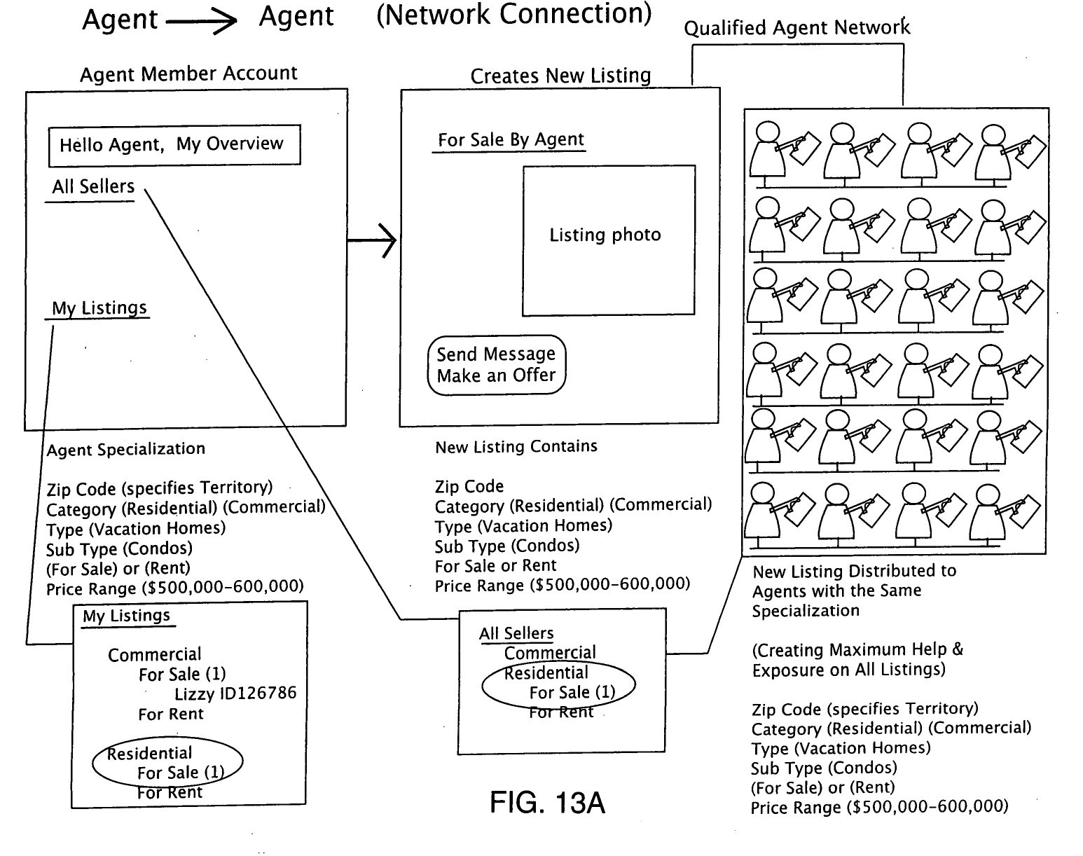

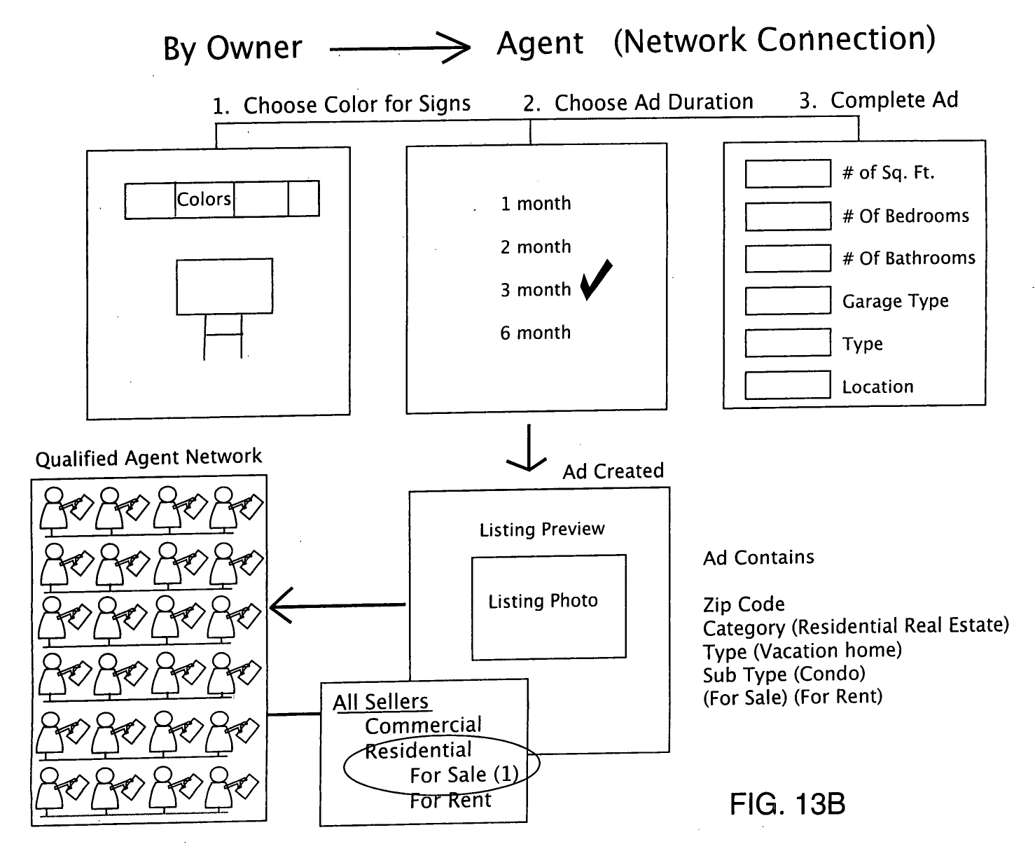

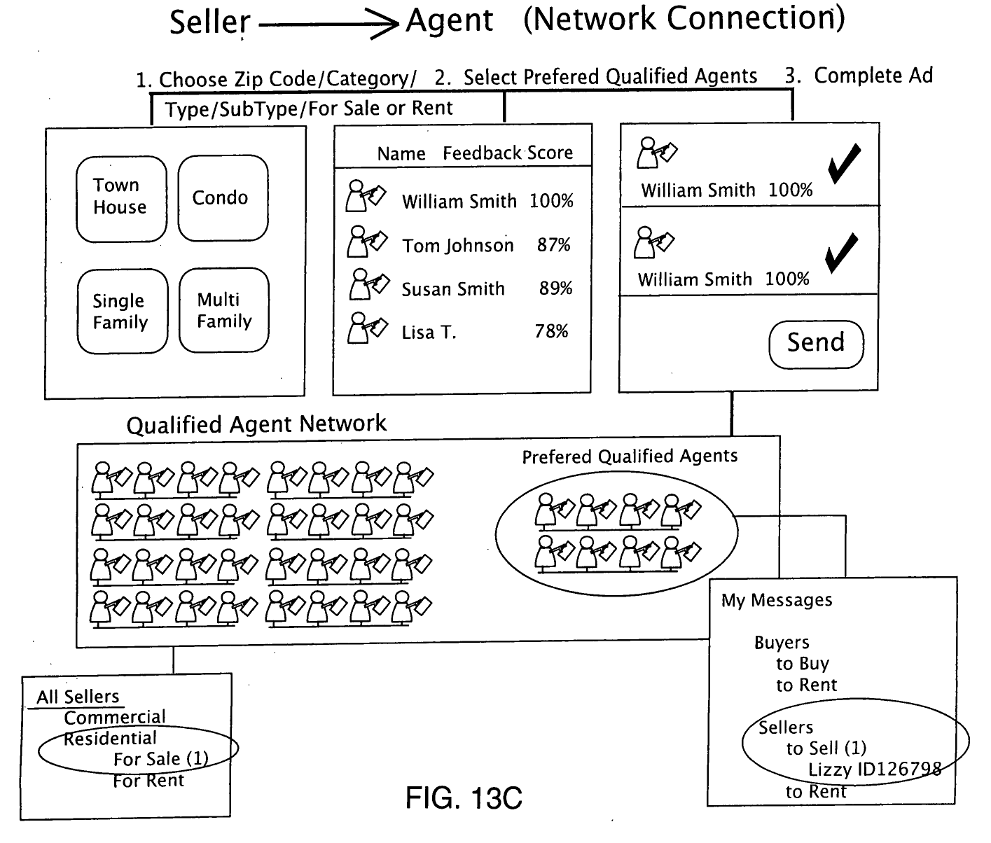

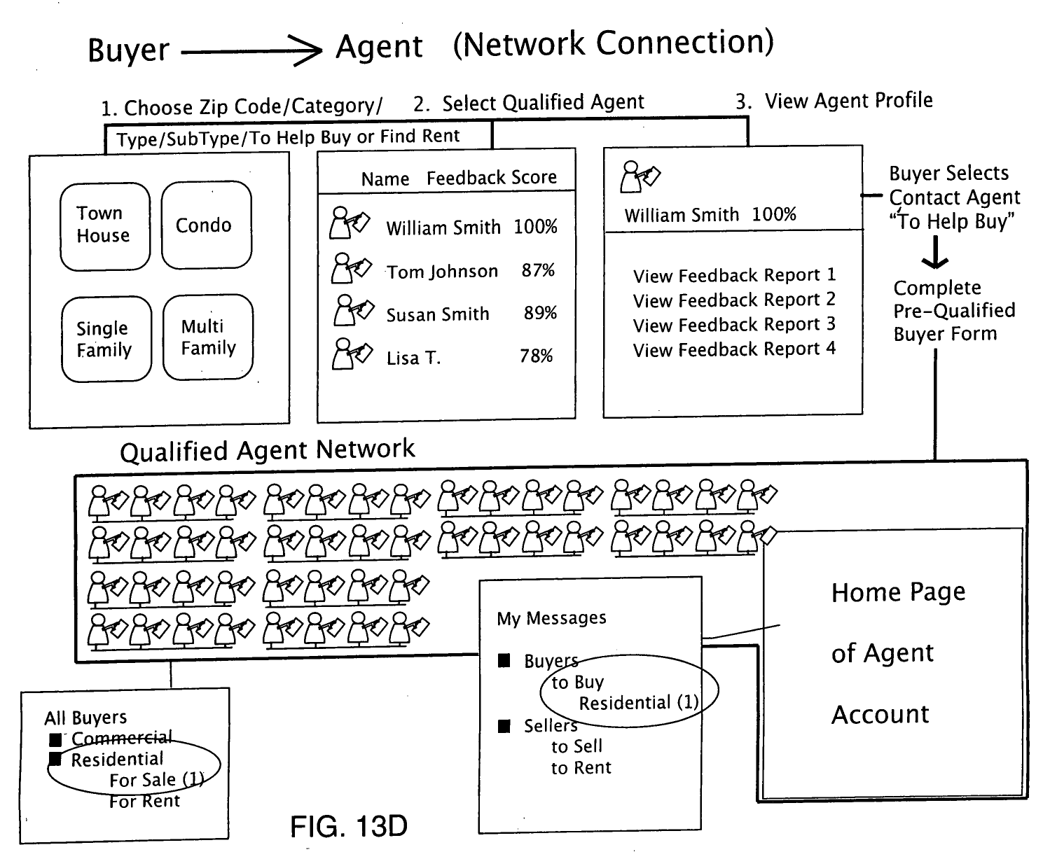

FIGS. 13A-13D depict a series of screens allowing system users to share information with each other. For example, an Agent using the system may choose to communicate certain information concerning a property with another Agent or a grouping of other Agents. This functionality allows Agents to be efficient with their time, minimizing the inefficiencies associated with “phone tag” and other traditional forms of communication.

While the foregoing description includes details and specificities, it should be understood that such details and specificities have been included for the purposes of explanation only, and are not to be interpreted as limitations of the present invention. Many modifications to the embodiments described above can be made without departing from the spirit and scope of the invention.

What is claimed is:

1. A computer-implemented method for seemnlessly integrating real estate property information from property owners selling real estate without the assistance of a real estate agent (e.g., a For Sale By Owner database) with real estate property information maintained in Realtor® databases (e.g., a Multiple Listing Service database), thereby enabling buyers, and real estate agents working on behalf of buyers, to search for properties possessing certain user-specified property attributes through a single search process, the computer-implemented method comprising:
(a) comparing a user's property preferences to data stored in a plurality of databases wherein the databases comprise at least one non-Realtor® maintained real estate database and at least one Realtor® -maintained real estate database;
(b) identifying properties of interest to the user from the plurality of databases;
(c) formatting a listing representing the identified properties of interest; and
(d) providing the listing to the user.

2. The computer-implemented method of claim 1, further comprising:
a means of allowing real estate owners to initially list a property for sale without the assistance of a real estate agent and subsequently convert the listing to one listed by a real estate agent by allowing the owner to select an agent from a listing of one or more agents identified based on previously stored agent specialization and geographic information and that match previously-stored attributes for the property.

3. The computer-implemented method of claim 2, further comprising:
a means of allowing the owner to electronically communicate with each identified agent before the owner selects an agent to list the property.

4. The computer-implemented method of claim 2, further comprising:
a means of electronically transferring property information maintained by the owner to the selected agent.

5. The computer-implemented method of claim 2, further comprising:
a means of automatically converting a property listed by the owner to a property listed by a real estate agent after an owner-specified timeframe.

6. The computer-implemented method of claim 1, further comprising:
a means of allowing owners listing their own property to pay a pre-determined commission to real estate agents that represent a buyer of the property wherein the owner may change the commission from time to time.

7. The computer-implemented method of claim 6 wherein a real estate agent's single search of the non-Realtor® and Realtor® databases results in a listing of only properties where the owner of the property has agreed to pay a commission for the sale of the property.

8. The computer-implemented method of claim 6 wherein the pre-determined commission paid to a real estate agent representing a buyer may be automatically added to or revised on the owner's property at owner-specified timeframes.

9. The computer-implemented method of claim 8 wherein a real estate agent's single search of the non-Realtor® and Realtor® databases results in a listing of only properties where the owner of the property has agreed to pay a commission for the sale of the property.

10. The computer-implemented method of claim 1, further comprising:
a means of allowing an open house to be scheduled for a property wherein notice of the open house is electronically transmitted to all agents specializing in that property type and all buyers that have previously indicated an interest in properties possessing the attributes of the open house property.

11. The computer-implemented method of claim 1, further comprising:
a means of allowing a property owner that has not yet listed his or her property in any manner to view a listing of all agents that specialize in selling properties in a given geographic area wherein the properties for sale possess attributes similar to the owner's property and allowing the owner to electronically communicate with any agent from the listing prior to selecting a specific agent to list the owner's property.

12. The computer-implemented method of claim 1, further comprising:
a means of allowing a prospective buyer to enter property attributes of interest and then view a listing of all real estate agents that specialize in selling properties or representing buyers within a given geographic area wherein the agent's specializations are similar to the buyer's property interests.

13. A computer program product comprising:
a computer-readable medium;
computer program instructions, wherein the computer instructions, when executed by a computer, direct the computer to perform a method for seemlessly integrating real estate property information from property owners selling real estate without the assistance of a real estate agent (e.g., a For Sale By Owner database) with real estate property information maintained in Realtor® databases (e.g., a Multiple Listing Service database), thereby enabling buyers, and real estate agents working on behalf of buyers, to search for properties possessing certain user-specified property attributes through a single search process, the computer-implemented method comprising:
(a) comparing a user's property preferences to data stored in a plurality of databases wherein the databases comprise at least one non-Realtor® maintained real estate database and at least one Realtor®-maintained real estate database;
(b) identifying properties of interest to the user from the plurality of databases;
(c) formatting a listing representing the identified properties of interest; and
(d) providing the listing to the user.

14. The computer program product of claim 13, further comprising:
a means of allowing real estate owners to initially list a property for sale without the assistance of a real estate agent and subsequently convert the listing to one listed by a real estate agent by allowing the owner to select an agent from a listing of one or more agents identified based on previously stored agent specialization and geographic information and that match previously-stored attributes for the property.

15. The computer program product of claim 14, further comprising:
a means of allowing the owner to electronically communicate with each identified agent before the owner selects an agent to list the property.

16. The computer program product of claim 14, further comprising:
a means of electronically transferring property information maintained by the owner to the selected agent.

17. The computer program product of claim 14, further comprising:
a means of automatically converting a property listed by the owner to a property listed by a real estate agent after an owner-specified timeframe.

18. The computer program product of claim 13, further comprising:
a means of allowing owners listing their own property to pay a pre-determined commission to real estate agents that represent a buyer of the property wherein the owner may change the commission from time to time.

19. The computer program product of claim 18 wherein a real estate agent's single search of the non-Realtor® and Realtor® databases results in a listing of only properties where the owner of the property has agreed to pay a commission for the sale of the property.

20. The computer program product of claim 18 wherein the pre-determined commission paid to a real estate agent representing a buyer may be automatically added to or revised on the owner's property at owner-specified timeframes.

21. The computer program product of claim 20 wherein a real estate agent's single search of the non-Realtor® and Realtor® databases results in a listing of only properties where the owner of the property has agreed to pay a commission for the sale of the property.

22. The computer program product of claim 13, further comprising:
a means of allowing an open house to be scheduled for a property wherein notice of the open house is electronically transmitted to all agents specializing in that property type and all buyers that have previously indicated an interest in properties possessing the attributes of the open house property.

23. The computer program product of claim 13, further comprising:
a means of allowing a property owner that has not yet listed his or her property in any manner to view a listing of all agents that specialize in selling properties in a given geographic area wherein the properties for sale possess attributes similar to the owner's property and allowing the owner to electronically communicate with any agent from the listing prior to selecting a specific agent to list the owner's property.

24. The computer program product of claim 13, further comprising:
a means of allowing a prospective buyer to enter property attributes of interest and then view a listing of all real estate agents that specialize in selling properties or representing buyers within a given geographic area wherein the agent's specializations are similar to the buyer's property interests.
